(19) United States
(12) Patent Application Publication
(10) Pub. No.: US 2014/0193089 A1
(43) Pub. Date: Jul. 10, 2014

(54) IMAGE PROCESSING DEVICE AND METHOD

(71) Applicant: SONY CORPORATION, Minato-ku (JP)

(72) Inventor: Kazushi Sato, Kanagawa (JP)

(73) Assignee: SONY CORPORATION, Minato-ku (JP)

(21) Appl. No.: 14/344,166

(22) PCT Filed: Oct. 25, 2012
(86) PCT No.: PCT/JP2012/077578

§ 371 Date: Mar. 11, 2014

(30) Foreign Application Priority Data
Nov. 2, 2011 (JP) 2011-241692

(51) Int. Cl. H04N 19/124

(52) U.S. Cl. CPC H04N 19/0009
USPC 382/251

(57) ABSTRACT

The present disclosure relates to an image processing device and a method that can suppress decreases in encoding efficiency.

An image processing device of the present disclosure includes: a transform unit that transforms the quantization parameter used in quantization of image data into parameters; and a transmission unit that transmits the parameters generated from the quantization parameter transformed by the transform unit. For example, at the time of encoding of image data, the quantization parameter of the image data is divided by 2 and is transformed into a parameter indicating the quotient and a parameter indicating the remainder, and the parameters are transmitted. The present disclosure can be applied to image processing devices.

### TECHNICAL FIELD

The present disclosure relates to image processing devices and methods, and relates to an image processing device and a method that suppress decreases in encoding efficiency.

### BACKGROUND ART

In recent years, to handle image information as digital information and achieve high-efficiency information transmission and accumulation in doing do, apparatuses compliant with a standard, such as MPEG (Moving Picture Experts Group) for compressing image information through orthogonal transforms such as discrete cosine transforms and motion compensation by taking advantage of redundancy inherent to the image information, have spread among broadcast stations to distribute information and among general households to receive information.

Particularly, MPEG2 (ISO (International Organization for Standardization)/IEC (International Electrotechnical Commission) 13818-2) is defined as a general-purpose image encoding standard, and is applicable to interlaced images and non-interlaced images, and to standard-resolution images and high-definition images. Currently, MPEG2 is used in a wide range of applications for professionals and general consumers. According to the MPEG2 compression method, a bit rate of 4 to 8 Mbps is assigned to an interlaced image having a standard resolution of 720×480 pixels, and a bit rate of 18 to 22 Mbps is assigned to an interlaced image having a high-resolution of 1920×1088 pixels, for example. In this manner, high compression rates and excellent image quality can be realized.

MPEG2 is designed mainly for high-quality image encoding suited for broadcasting, but is not compatible with lower bit rates than MPEG1 or encoding methods involving higher compression rates. As mobile terminals are becoming popular, the demand for such encoding methods is expected to increase in the future, and to meet the demand, the MPEG4 encoding method was standardized. As for an image encoding method, the ISO/IEC 14496-2 standard was approved as an international standard in December 1998.

Further, a standard called H.26L (ITU-T (International Telecommunication Union Telecommunication Standardization Sector) Q6/16 VCEG (Video Coding Expert Group)), which is originally intended for encoding images for video conferences, is currently being set. Compared with the conventional encoding techniques such as MPEG2 and MPEG4, H.26L requires a larger amount of calculation in encoding and decoding, but is known to achieve higher encoding efficiency. Also, as a part of the MPEG4 activity, “Joint Model of Enhanced-Compression Video Coding” has been established as a standard for achieving higher encoding efficiency by incorporating functions unsupported by H.26L into the functions based on H.26L.

On the standardization schedule, the standard was approved as an international standard under the name of H.264 and MPEG-4 Part 10 (Advanced Video Coding, hereinafter referred to as AVC) in March 2003.

In AVC, a hierarchical structure formed with macroblocks and sub-macroblocks is specified as a unit of processing in encoding (unit of encoding). However, this macroblock size of 16×16 pixels is not optimal for a large frame such as a UHD (Ultra High Definition: 4000×2000 pixels) frame to be encoded by a next-generation encoding method.

In view of this, Coding Units (CUs), instead of macroblocks, are specified as units of encoding in HEVC (High Efficiency Video Coding), which is a PostAVC encoding technique (see Non-Patent Document 1, for example).

In AVC and HEVC, coefficient data generated from image data to be encoded is quantized before being encoded. In recent years, there has been a demand for an increase in accuracy of the quantization. To increase quantization accuracy, a relationship between a quantization step and a quantization parameter is redefined, for example.

### CITATION LIST

### Non-Patent Document

Non-Patent Document 1: Benjamin Bross, Woo-Jin Han, Jens-Rainer Ohm, Gary J. Sullivan, Thomas Wiegand,” Working Draft 4 of High-Efficiency Video Coding”, JCTVC-F803_d2, Joint Collaborative Team on Video Coding (JCT-VC) of ITU-T SG16 WP3 and ISO/IEC JTC1/SC29/WG11 6th Meeting: Torino, IT, 14-22 July, 2011

### SUMMARY OF THE INVENTION

### Problems to be Solved by the Invention

However, when a relationship between a quantization parameter and a quantization step is simply redefined so as to increase quantization accuracy, there is a risk that the range within which the value of the quantization parameter can vary becomes wider with respect to the same range, and the bit rate becomes higher accordingly.

In the case of HEVC, for example, a quantization parameter (ΔQP) is encoded by Golomb coding or the like and is then transmitted from the encoding side to the decoding side, for each of the data units called Coding Units. However, when the range within which the value of a quantization parameter can vary becomes wider, the bit rate of the quantization parameter becomes much higher, and, as a result, the encoding efficiency of the entire bit stream might become lower.

The present disclosure is made in view of those circumstances, and aims to suppress the increase in bit rate caused by an increase in quantization accuracy, and suppress the decrease in encoding efficiency.

### Solutions to Problems

One aspect of the present disclosure is an image processing device that includes: a transform unit that transforms the quantization parameter used in quantization of image data into parameters; and a transmission unit that transmits the parameters generated from the quantization parameter transformed by the transform unit.

The transform unit may transform the quantization parameter into a first quantization parameter and a second quantization parameter.

The transform unit may set the quotient obtained by dividing the quantization parameter by 2 as the first quantization parameter, and the remainder as the second quantization parameter.

The transform unit may realize the division of the quantization parameter through a shift operation.

The transform unit may further calculate a difference first quantization parameter that is a difference value between the first quantization parameter of the current region being processed and a predicted first quantization parameter that is a predicted value of the first quantization parameter of the current region.

The transform unit may calculate the predicted first quantization parameter by using the first quantization parameter of an adjacent region of the current region.

When the region adjacent to the left side of the current region is available, the transform unit may set the region adjacent to the left side of the current region as the adjacent region. When the region adjacent to the left side of the current region is unavailable, the transform unit may set the region processed immediately before the current region as the adjacent region.

The transmission unit may encode the difference first quantization parameter, and transmit the encoded difference first quantization parameter and the second quantization parameter.

The image processing device may further include a quantization unit that quantizes the image data, and the transform unit may transform the quantization parameter used in the quantization of the image data performed by the quantization unit, into parameters.

The image processing device may further include an encoding unit that encodes the quantized image data, and the transmission unit may add the parameters to encoded data of the image data generated by the encoding unit, and transmit the parameters added to the encoded data.

The one aspect of the present disclosure is also an image processing method implemented in an image processing device. The image processing method includes: transforming a quantization parameter used in quantization of image data into parameters, the transforming being performed by a transform unit; and transmitting the parameters generated by transforming the quantization parameter, the transmitting being performed by a transmission unit.

The other aspect of the present disclosure is an image processing device that includes: an acquisition unit that acquires parameters generated by transforming a quantization parameter used in quantization of image data; and a reconstruction unit that reconstructs the quantization parameter by using the parameters acquired by the acquisition unit.

The acquisition unit may acquire a difference first quantization parameter and a second quantization parameter, the difference first quantization parameter being a difference value between a first quantization parameter generated by transforming the quantization parameter of the current region being processed and a predicted first quantization parameter that is a predicted value of the first quantization parameter, the second quantization parameter being generated by transforming the quantization parameter of the current region. The reconstruction unit may reconstruct the first quantization parameter of the current region by using the difference first quantization parameter of the current region acquired by the acquisition unit, and further reconstruct the quantization parameter of the current region by using the reconstructed first quantization parameter of the current region and the second quantization parameter of the current region.

The reconstruction unit may calculate the predicted first quantization parameter by using the first quantization parameter of an adjacent region of the current region, and reconstruct the first quantization parameter of the current region by adding the calculated predicted first quantization parameter to the difference first quantization parameter of the current region.

The first quantization parameter may be the quotient obtained by dividing the quantization parameter by 2, and the second quantization parameter may be the remainder obtained by dividing the quantization parameter by 2.

The reconstruction unit may reconstruct the first quantization parameter of the current region by multiplying the first quantization parameter by 2 and adding the second quantization parameter.

The reconstruction unit may realize the multiplication of the quantization parameter through a shift operation.

The acquisition unit may acquire the difference first quantization parameter by decoding the difference first quantization parameter encoded.

The image processing device may further include: an inverse quantization unit that inversely quantizes the quantized image data by using the quantization parameter reconstructed by the reconstruction unit.

The other aspect of the present disclosure is also an image processing method implemented in an image processing device. The image processing method includes: acquiring parameters generated by transforming the quantization parameter used in quantization of image data, the acquiring being performed by an acquisition unit; and reconstructing the quantization parameter by using the acquired parameters, the reconstructing being performed by a reconstruction unit.

In the one aspect of the present disclosure, the quantization parameter used in quantization of image data is transformed into parameters, and the parameters generated by transforming the quantization parameter are transmitted.

In the other aspect of the present disclosure, parameters generated by transforming the quantization parameter used in quantization of image data are acquired, and the quantization parameter is reconstructed by using the acquired parameters.

### Effects of the Invention

According to the present disclosure, images can be processed. Particularly, decreases in encoding efficiency can be suppressed.

### BRIEF DESCRIPTION OF DRAWINGS

FIG. 1 is a block diagram showing a typical example structure of an image encoding device.

FIG. 2 is a diagram for explaining example structures of coding units.

FIG. 3 is a diagram showing an example of a relationship between a quantization step and a quantization parameter.

FIG. 4 is a diagram showing an example of syntax in a picture parameter set.

FIG. 5 is a table showing an example of syntax for transform coefficients.

FIG. 6 is a diagram showing example tables to be used in encoding a quantization parameter.

FIG. 7 is a block diagram showing a typical example structure of a quantization parameter encoding unit.

FIG. 8 is a diagram for explaining quantization parameter predictions.

FIG. 9 is a flowchart for explaining an example flow of an encoding process.

FIG. 10 is a flowchart for explaining an example flow of a quantization parameter encoding process.

FIG. 11 is a block diagram showing a typical example structure of an image decoding device.

FIG. 12 is a block diagram showing a typical example structure of a quantization parameter decoding unit.

FIG. 13 is a flowchart for explaining an example flow of a decoding process.

FIG. 14 is a flowchart for explaining an example flow of a quantization parameter decoding process.

FIG. 15 is a block diagram showing a typical example structure of a computer.

FIG. 16 is a block diagram showing a typical example structure of a television apparatus.

FIG. 17 is a block diagram showing a typical example structure of a mobile device.

FIG. 18 is a block diagram showing a typical example structure of a recording/reproducing apparatus.

FIG. 19 is a block diagram showing a typical example structure of an imaging apparatus.

### MODES FOR CARRYING OUT THE INVENTION

The following is a description of modes for embodying this disclosure (hereinafter referred to as the embodiments). Explanation will be made in the following order.

1. First Embodiment (Image Encoding Device)

2. Second Embodiment (Image Decoding Device)

3. Third Embodiment (Computer)

4. Fourth Embodiment (Television Receiver)

5. Fifth Embodiment (Portable Telephone Device)

6. Sixth Embodiment (Recording/Reproducing Apparatus)

7. Seventh Embodiment (Imaging Apparatus)

### 1. First Embodiment

[Image Encoding Device]

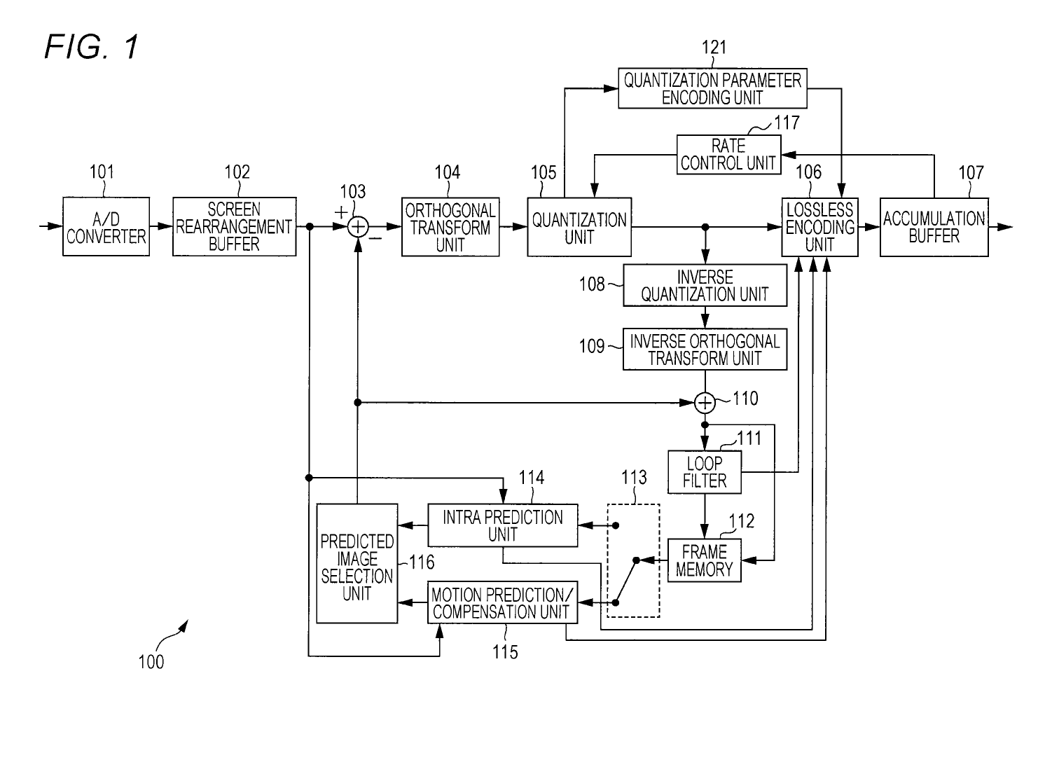

FIG. 1 is a block diagram showing a typical example structure of an image encoding device that is an image processing device to which the present technique is applied.

The image encoding device 100 shown in FIG. 1 encodes image data of moving images by the HEVC (High Efficiency Video Coding) technique or the H.264/MPEG (Moving Picture Experts Group) 4 Part 10 (AVC (Advanced Video Coding)) technique, for example.

As shown in FIG. 1, the image encoding device 100 includes an A/D converter 101, a screen rearrangement buffer 102, an arithmetic operation unit 103, an orthogonal transform unit 104, a quantization unit 105, a lossless encoding unit 106, and an accumulation buffer 107. The image encoding device 100 also includes an inverse quantization unit 108, an inverse orthogonal transform unit 109, an arithmetic operation unit 110, a loop filter 111, a frame memory 112, a selection unit 113, an intra prediction unit 114, a motion prediction/compensation unit 115, a predicted image selection unit 116, and a rate control unit 117. The image encoding device 100 further includes a quantization parameter encoding unit 121.

The A/D converter 101 subjects input image data to an A/D conversion, and supplies and stores the converted image data (digital data) into the screen rearrangement buffer 102. The screen rearrangement buffer 102 rearranges the image having frames stored in displaying order in accordance with the GOP (Group of Pictures) structure, so that the frames are arranged in frame order for encoding. The image having the frames rearranged is supplied to the arithmetic operation unit 103. The screen rearrangement buffer 102 supplies each frame image to the arithmetic operation unit 103 for each predetermined partial region that serves as a unit of processing (a unit of encoding) in an encoding process.

The screen rearrangement buffer 102 also supplies the image having the rearranged frame order to the intra prediction unit 114 and the motion prediction/compensation unit 115 for each partial region.

The arithmetic operation unit 103 subtracts a predicted image supplied from the intra prediction unit 114 or the motion prediction/compensation unit 115 via the predicted image selection unit 116, from the image read from the screen rearrangement buffer 102, and outputs the difference information to the orthogonal transform unit 104. When intra encoding is to be performed on an image, for example, the arithmetic operation unit 103 subtracts a predicted image supplied from the intra prediction unit 114, from the image read from the screen rearrangement buffer 102. When inter encoding is to be performed on an image, for example, the arithmetic operation unit 103 subtracts a predicted image supplied from the motion prediction/compensation unit 115, from the image read from the screen rearrangement buffer 102.

The orthogonal transform unit 104 performs an orthogonal transform, such as a discrete cosine transform or a Karhunen-Loeve transform, on the difference information supplied from the arithmetic operation unit 103. This orthogonal transform is performed by any appropriate method. The orthogonal transform unit 104 supplies the transform coefficient obtained through the orthogonal transform to the quantization unit 105.

The quantization unit 105 quantizes the transform coefficient supplied from the orthogonal transform unit 104. The quantization unit 105 supplies the quantized transform coefficient to the lossless encoding unit 106.

The quantization unit 105 also supplies the quantization parameter used in the quantization to the quantization parameter encoding unit 121.

The lossless encoding unit 106 encodes the transform coefficient quantized by the quantization unit 105 by an appropriate encoding method, and generates encoded data (a bit stream). Since the coefficient data has already been quantized under the control of the rate control unit 117, the bit rate of this encoded data becomes equal to the target value (or approximates the target value) that is set by the rate control unit 117.

The lossless encoding unit 106 acquires intra prediction information indicating an intra prediction mode and the like from the intra prediction unit 114, and acquires inter prediction information indicating an inter prediction mode, motion vector information, and the like from the motion prediction/compensation unit 115. The lossless encoding unit 106 further acquires the filter coefficient and the like used at the loop filter 111.

The lossless encoding unit 106 also acquires quantization-related parameters from the quantization parameter encoding unit 121. For example, the lossless encoding unit 106 acquires a difference first quantization parameter and a second quantization parameter that are generated as quantization-related parameters by the quantization parameter encoding unit 121. These parameters will be described later.

The lossless encoding unit 106 encodes those various kinds of information by an appropriate encoding method, and incorporates the information into (or multiplexes the information with) the encoded data (bit stream). For example, the lossless encoding unit 106 binarizes and encodes the above described quantization-related parameters (the difference first quantization parameter and the second quantization parameter, for example) one by one, and stores the quantization-related parameters in the header information or the like of the encoded data of the image data.

The lossless encoding unit 106 supplies and stores the encoded data generated in the above manner into the accumulation buffer 107. The encoding method used by the lossless encoding unit 106 may be variable-length encoding or arithmetic encoding, for example. The variable-length encoding may be CAVLC (Context-Adaptive Variable Length Coding) specified in H.264/AVC, for example. The arithmetic encoding may be CABAC (Context-Adaptive Binary Arithmetic Coding), for example.

The accumulation buffer 107 temporarily holds the encoded data supplied from the lossless encoding unit 106. The accumulation buffer 107 outputs the encoded data held therein as a bit stream to a recording device (a recording medium) or a transmission path or the like (not shown) in a later stage, for example, at a predetermined time. That is, the encoded information of various kinds is supplied to the device (hereinafter also referred to as the device on the decoding side) that decodes encoded data obtained by the image encoding device 100 encoding image data.

The transform coefficient quantized by the quantization unit 105 is also supplied to the inverse quantization unit 108. The inverse quantization unit 108 inversely quantizes the quantized transform coefficient by a method compatible with the quantization performed by the quantization unit 105. The inverse quantization unit 108 supplies the obtained transform coefficient to the inverse orthogonal transform unit 109.

The inverse orthogonal transform unit 109 performs an inverse orthogonal transform on the transform coefficient supplied from the inverse quantization unit 108 by a method compatible with the orthogonal transform performed by the orthogonal transform unit 104. The output subjected to the inverse orthogonal transform (the locally restored difference information) is supplied to the arithmetic operation unit 110.

The arithmetic operation unit 110 obtains a locally reconstructed image (hereinafter referred to as the reconstructed image) by adding a predicted image supplied from the intra prediction unit 114 or the motion prediction/compensation unit 115 via the predicted image selection unit 116 to the inverse orthogonal transform result supplied from the inverse orthogonal transform unit 109 or the locally restored difference information. The reconstructed image is supplied to the loop filter 111 or the frame memory 112.

The loop filter 111 includes a deblocking filter, an adaptive loop filter, and the like, and, where appropriate, performs a filtering process on the reconstructed image supplied from the arithmetic operation unit 110. For example, the loop filter 111 performs a deblocking filtering process on the reconstructed image, to remove block distortion from the reconstructed image. Also, the loop filter 111 improves image quality by performing a loop filtering process using a Wiener filter on the result of the deblocking filtering process (the reconstructed image from which block distortion has been removed), for example.

The loop filter 111 may further perform other appropriate filtering processes on the reconstructed image. Also, the loop filter 111 can supply information such as the filter coefficient used in the filtering process to the lossless encoding unit 106 to encode the information, if necessary.

The loop filter 111 supplies the result of the filtering process (hereinafter referred to as the decoded image) to the frame memory 112.

The frame memory 112 stores both the reconstructed image supplied from the arithmetic operation unit 110 and the decoded image supplied from the loop filter 111. At a predetermined time or in accordance with a request from outside such as from the intra prediction unit 114, the frame memory 112 supplies the stored reconstructed image to the intra prediction unit 114 via the selection unit 113. At a predetermined time or in accordance with a request from outside such as from the motion prediction/compensation unit 115, the frame memory 112 supplies the stored decoded image to the motion prediction/compensation unit 115 via the selection unit 113.

The selection unit 113 indicates the destination to which an image output from the frame memory 112 is to be supplied. In the case of an intra prediction, for example, the selection unit 113 reads the image not subjected to a filtering process (the reconstructed image) from the frame memory 112, and supplies the image as an adjacent pixel to the intra prediction unit 114.

In the case of an inter prediction, for example, the selection unit 113 reads the image subjected to a filtering process (the decoded image) from the frame memory 112, and supplies the image as a reference image to the motion prediction/compensation unit 115.

Acquiring an image of an adjacent region located adjacent to the current region (an adjacent image) from the frame memory 112, the intra prediction unit 114 performs intra predictions (intra-screen predictions) to generate predicted images by using the pixel value of the adjacent image, with the unit of processing being basically a Prediction Unit (PU). The intra prediction unit 114 performs the intra predictions in more than one mode (intra prediction modes) that is prepared in advance.

The intra prediction unit 114 generates predicted images in all the candidate intra prediction modes, evaluates the cost function values of the respective predicted images by using the input image supplied from the screen rearrangement buffer 102, and selects an optimum mode. After selecting the optimum intra prediction mode, the intra prediction unit 114 supplies the predicted image generated in the optimum intra prediction mode to the predicted image selection unit 116.

The intra prediction unit 114 also supplies the intra prediction information including intra-prediction-related information such as the optimum intra prediction mode to the lossless encoding unit 106, which then encodes the intra prediction information.

Using the input image supplied from the screen rearrangement buffer 102, and the reference image supplied from the frame memory 112, the motion prediction/compensation unit 115 performs motion predictions (inter predictions), and performs a motion compensation process in accordance with the detected motion vectors, to generate a predicted image (inter-predicted image information). In the motion predictions, a PU (inter PU) is used basically as a unit of processing. The motion prediction/compensation unit 115 performs such inter predictions in more than one mode (inter prediction modes) that is prepared in advance.

Specifically, the motion prediction/compensation unit 115 generates predicted images in all the candidate inter prediction modes, evaluates the cost function values of the respective predicted images, and selects an optimum mode. After selecting the optimum inter prediction mode, the motion prediction/compensation unit 115 supplies the predicted image generated in the optimum intra prediction mode to the predicted image selection unit 116.

The motion prediction/compensation unit 115 also supplies the inter prediction information including inter-prediction-related information such as the optimum inter prediction mode to the lossless encoding unit 106, which then encodes the inter prediction information.

The predicted image selection unit 116 selects the supplier of the predicted image to be supplied to the arithmetic operation unit 103 and the arithmetic operation unit 110. In the case of intra encoding, for example, the predicted image selection unit 116 selects the intra prediction unit 114 as the supplier of a predicted image, and supplies the predicted image supplied from the intra prediction unit 114 to the arithmetic operation unit 103 and the arithmetic operation unit 110. In the case of inter encoding, for example, the predicted image selection unit 116 selects the motion prediction/compensation unit 115 as the supplier of a predicted image, and supplies the predicted image supplied from the motion prediction/compensation unit 115 to the arithmetic operation unit 103 and the arithmetic operation unit 110.

Based on the bit rate of the encoded data accumulated in the accumulation buffer 107, the rate control unit 117 controls the quantization operation rate of the quantization unit 105 so as not to cause an overflow or underflow.

The quantization parameter encoding unit 121 acquires, from the quantization unit 105, the quantization parameter used in the quantization process by the quantization unit 105, and converts the quantization parameter into more than one parameter. Specifically, the quantization parameter encoding unit 121 generates quantization-related parameters by using the quantization parameter supplied from the quantization unit 105. For example, the quantization parameter encoding unit 121 generates the difference first quantization parameter and the second quantization parameter as the quantization-related parameters. These parameters will be described later. The quantization parameter encoding unit 121 supplies the generated quantization-related parameters to the lossless encoding unit 106, which then encodes the quantization-related parameters and transmits the encoded quantization-related parameter to the device on the decoding side.

[Coding Units]

Coding Units (CUs) specified by the HEVC encoding technique is now described.

Coding Units (CUs) are also called Coding Tree Blocks (CTBs), and are partial regions of picture-based images that have the same roles as those of macroblocks in AVC. That is, CUs are units for encoding processes (units of encoding). While the size of a macroblock is limited to 16×16 pixels, the size of a CU is not limited to a certain size, and may be designated by compressed image information in each sequence.

Particularly, a CU having the largest size is called a Largest Coding Unit (LCU), and a CU having the smallest size is called a Smallest Coding Unit (SCU). That is, LCU is the largest unit of encoding, and SCU is the smallest unit of encoding. In a sequence parameter set included in compressed image information, for example, the sizes of those regions are designated, but the regions are restricted to squares represented by a power of 2. That is, the respective regions formed by dividing a (square) CU at a certain hierarchical level by 2×2, which is 4, are (square) CUs one hierarchical level lower.

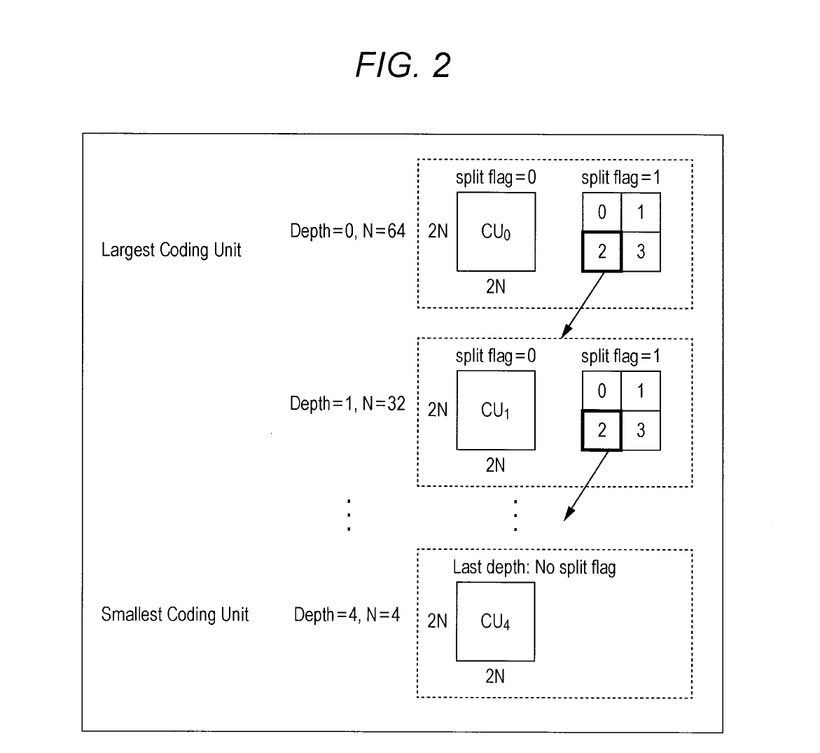

FIG. 2 shows examples of Coding Units defined in HEVC. In the example shown in FIG. 2, the size of the LCU is 128 (2N (N=64), and the greatest hierarchical depth is 5 (Depth=4). When the value of split flag is “1”, a CU of 2N×2N in size is divided into CUs of N×N in size, which are one hierarchical level lower.

Each of the CUs is further divided into Prediction Units (PUs) that are processing-unit regions (partial regions of picture-based images) for intra or inter predictions, or are divided into Transform Units (TUs) that are processing-unit regions (partial regions of picture-based images) for orthogonal transforms.

As for inter prediction units (PUs), the four sizes, 2N×2N, 2N×N, N×2N, and N×N, can be set in a CU of 2N×2N in size. Specifically, in a CU, it is possible to define a PU of the same size as the CU, two PUs formed by vertically or horizontally dividing the CU by two, or four PUs formed by vertically and horizontally dividing the CU by two.

The image encoding device 100 performs encoding-related processes, with such partial regions in picture-based images being units of processing. In the following, a case where the image encoding device 100 uses the CUs defined in HEVC as units of encoding is described. That is, LCU is the largest unit of encoding, and SCU is the smallest unit of encoding. However, the units of processing in the respective encoding processes to be performed by the image encoding device 100 are not limited to those, and may be arbitrarily set. For example, the macroblocks and sub-macroblocks defined in AVC may be used as units of processing.

In the following description, “(partial) regions” include all (or some of) the above described regions (such as macroblocks, sub-macroblocks, LCUs, CUs, SCUs, PUs, and TUs). The (partial) regions may of course include units other than the above described ones, and unsuitable units will be excluded depending on the contents of explanation.

[Quantization Parameter]

Next, quantization is described. The quantization unit 105 performs quantization that is a process of rounding a result obtained by dividing coefficient data by a quantization step, to an integer. The quantization unit 105 can reduce the value of a coefficient through this quantization. Accordingly, by encoding the coefficient (a quantized value) that is the result of the quantization, the image encoding device 100 can make the bit rate lower than that in a case where the orthogonal transform coefficient prior to quantization is encoded.

In other words, the bit rate can be adjusted depending on the size of the quantization step. Accordingly, rate control in a bit stream can be realized by controlling the size of the quantization step.

At the time of inverse quantization, a quantization step of the same size as the quantization step used in the quantization is required. According to AVC or HEVC, a quantization parameter, instead of the quantization step, is transferred to the device on the decoding side. A predetermined relationship is defined beforehand between the quantization step (QS) and the quantization parameter (QP). In the case of AVC, for example, a relationship expressed by the following equation (1) is defined.

$$\begin{matrix}[ Mathematical Formula 1 ] & \\ \frac{QS ( QP + 6 )}{QS ( QP )} = 2 & ( 1 )\end{matrix}$$

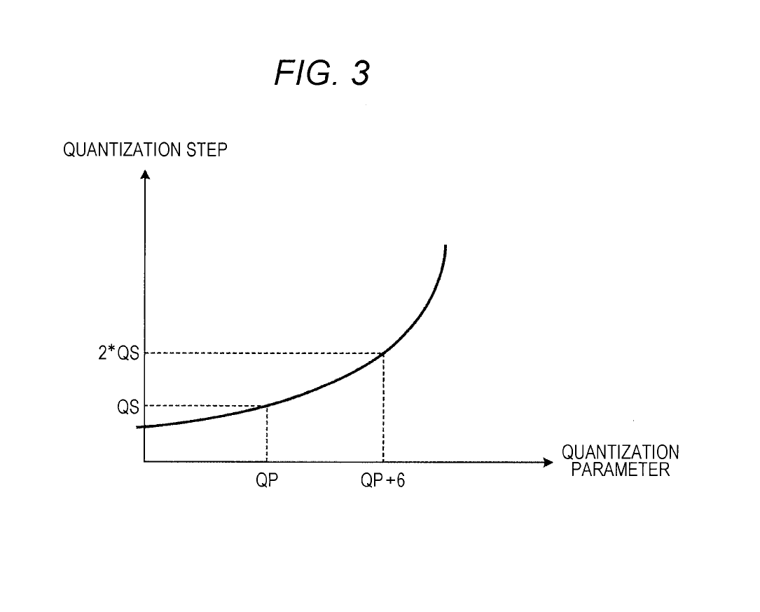

FIG. 3 is a diagram showing an example of a relationship between the quantization step (QS) and the quantization parameter (QP) in a graph. As shown in the graph in FIG. 3, the quantization step doubles when the quantization parameter increases by 6.

In accordance with the above relationship, a range within which the value of the quantization step can vary is defined beforehand depending on a desired range of the quantization step. In the case of AVC, for example, values ranging from 0 to 51 are defined as quantization parameter values, so that the maximum value of the quantization step is 256 times greater than the minimum value.

As described above, the quantization parameters (QPs) used in quantization in the device on the encoding side are transmitted to the device on the decoding side. In the case of HEVC, for example, a quantization parameter QP can be transmitted for each CU. As described above, CUs form a hierarchical structure, and CUs of two or more difference sizes can be formed in a LCU. The image encoding device 100 can transmit only the quantization parameters about CUs of a certain size and larger.

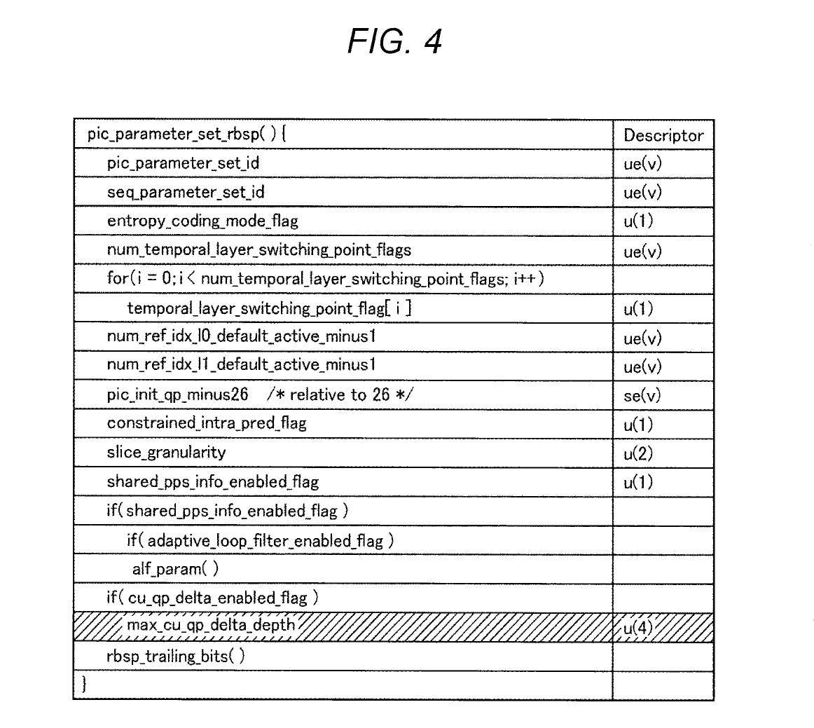

The smallest size of the CUs about which quantization parameters are to be transmitted is designated by max_cu_qp_delta_depth, which is a syntax element in the picture parameter set shown in FIG. 4, for example.

In the case of HEVC, to reduce the bit rate, a difference value (a difference quantization parameter) between the quantization parameter of the current CU and the quantization parameter of a CU adjacent to the current CU is transmitted, instead of the quantization parameter of the current CU that is the CU being processed.

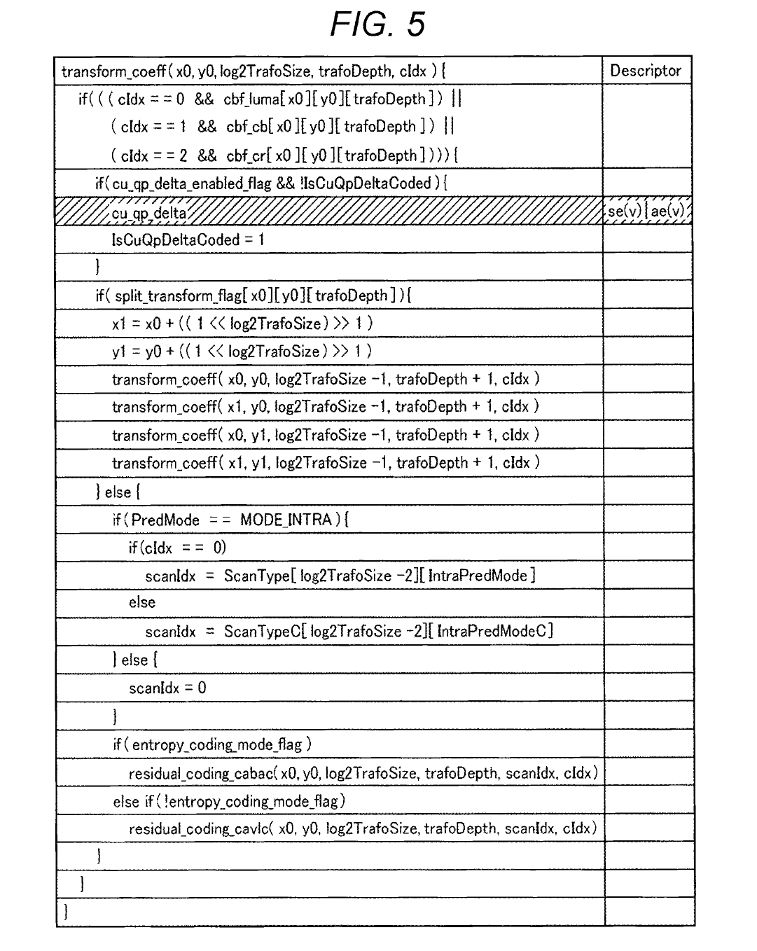

FIG. 5 is a table showing an example of syntax for transform coefficients. As shown in FIG. 5, the parameter cu_qp_delta, which represents the difference quantization parameter of the current CU, is transmitted for each of the CUs of sizes equal to and larger than the size designated by the above mentioned syntax element max_cu_qp_delta_depth.

This difference quantization parameter cu_qp_delta is calculated according to the following equations (2).

If(left_available)

QP=cu_{—}qp_delta+LeftQP

Else

QP=cu_{—}qp_delta+PrevQP (2)

Here, LeftQP represents the quantization parameter of the CU located on the left side of the current CU, and PrevQP represents the quantization parameter of the CU processed immediately before the current CU. That is, the difference value between the quantization parameter of the current CU and the quantization parameter of the CU located on the left side of the current CU or the CU processed immediately before the current CU is transmitted.

[Improvement in Quantization Accuracy and Increase in Bit Rate]

In recent years, there has been a demand for higher accuracy in the above described quantization. Specifically, the value of the quantization step is desired to be controlled more minutely with a quantization parameter.

To increase quantization accuracy, a relationship between the quantization parameter and the quantization step is redefined as shown in the following equation (3), for example.

$$\begin{matrix}[ Mathematical Formula 2 ] & \\ \frac{QS ( QP + 12 )}{QS ( QP )} = 2 & ( 3 )\end{matrix}$$

In the example shown in the equation (3), the quantization step doubles when the quantization parameter increases by 12.

By this method, however, the range within which the value of the quantization parameter can vary is wider with respect to the range of the value of the same quantization step, than that prior to the redefinition of a relationship between the quantization parameter and the quantization step.

For example, if the maximum value of the quantization step is made 256 times greater than the minimum value thereof as in the case of AVC, for example, the range within which the value of the quantization parameter can vary will be from 0 to 103.

If the range within which the value of the quantization parameter can vary becomes wider, the range within which the value of the difference quantization parameter can vary will also become wider. As described above, the difference quantization parameter is encoded and is then transmitted. Therefore, if the range within which the value of the difference quantization parameter can vary becomes wider, there will be a risk of an increase in the bit rate.

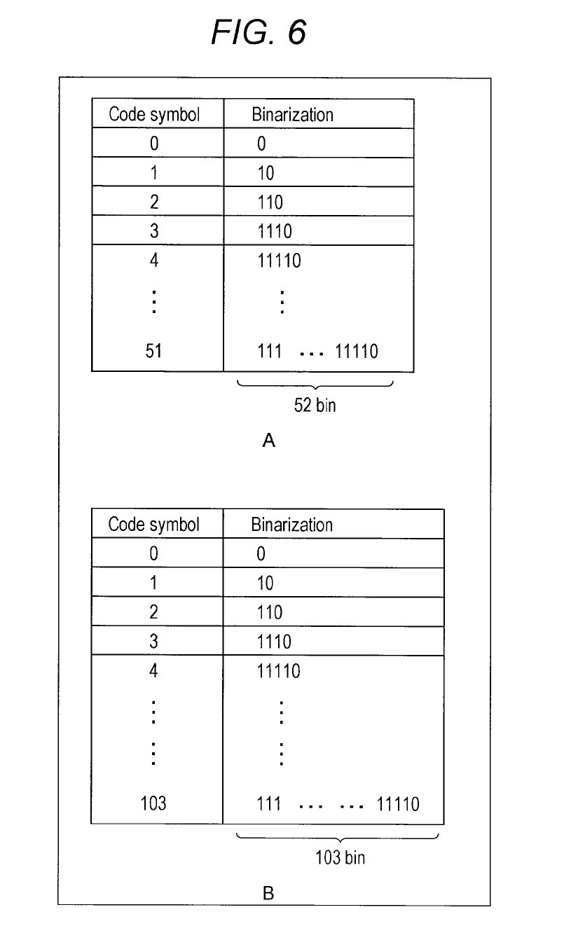

In the case of AVC, for example, the difference quantization parameter (deltaQP) can have values ranging from −26 to 26. In a case where encoding is performed by CABAC, for example, the difference quantization parameter is first transformed into unsigned data and is then binarized. Therefore, the range within which the value of the difference quantization parameter can vary is from 0 to 51. In view of this, the difference quantization parameter is encoded with the use of the table shown in A in FIG. 6.

In a case where the quantization parameter has the relationship shown in the above equation (3) with the quantization step, on the other hand, the range within which the value of the difference quantization parameter can vary is from 0 to 103. In view of this, the difference quantization parameter is encoded with the use of the table shown in B in FIG. 6.

Therefore, particularly when the quantization parameter is varied in a screen, there is a risk that the bit rate of cu_qp_delta will increase.

[Quantization Parameter Transform]

In view of the above, the image encoding device 100 transforms a quantization parameter with more than one parameter, so as to suppress the increase in the bit rate caused by an increase in quantization accuracy.

For example, the quantization parameter encoding unit 121 transforms a quantization parameter QP supplied from the quantization unit 105 into a first quantization parameter QP₁ and a second quantization parameter QP₂, as shown in the following equations (4) and (5).

QP₁=QP/2 (4)

QP₂=QP % 2 (5)

In the equation (4), QP/2 (or the first quantization parameter QP₁) represents the quotient obtained when the quantization parameter QP is divided by 2. In the equation (5), QP % 2 (or the second quantization parameter QP₂) represents the remainder obtained when the quantization parameter QP is divided by 2.

The quantization parameter encoding unit 121 calculates a difference value (the difference first quantization parameter) from a predicted value with respect to the first quantization parameter QP₁, and supplies the difference value to the lossless encoding unit 106 for encoding.

Meanwhile, the value of the second quantization parameter QP₂ is either “0” or “1”, or is 1-bit binary data. Therefore, the quantization parameter encoding unit 121 supplies the second quantization parameter QP₂ to the lossless encoding unit 106 as it is.

The lossless encoding unit 106 encodes the difference first quantization parameter, multiplexes the encoding result and the second quantization parameter QP₂ with encoded data, and transmits the encoded data to the device on the decoding side.

The relationship with the quantization step QS defined as shown in the equation (1) is redefined as shown in the equation (3), for example. If the range within which the value of the quantization parameter QP can vary is from 0 to 51 prior to the redefinition, the range within which the value of the quantization parameter QP can vary widens to the range of 0 to 103 after the redefinition, but the range within which the value of the first quantization parameter QP₁ can vary is from 0 to 51. That is, the bit rate of the difference first quantization parameter is the same as the bit rate of the difference quantization parameter prior to the redefinition.

Therefore, the bit rate after the redefinition increases only by the amount equivalent to the second quantization parameter QP₂ or one bit, compared with the bit rate prior to the redefinition. Accordingly, the image encoding device 100 can dramatically suppress the increase in the bit rate, compared with the bit rate in a case where the quantization parameter QP after the redefinition is encoded as it is.

The calculations (QP/2 and QP % 2) in the above equations (4) and (5) can be realized by a shift operation. That is, the image encoding device 100 can readily transform a quantization parameter into more than one parameters (and can suppress the increase in calculation load caused by this transform).

[Quantization Parameter Encoding Unit]

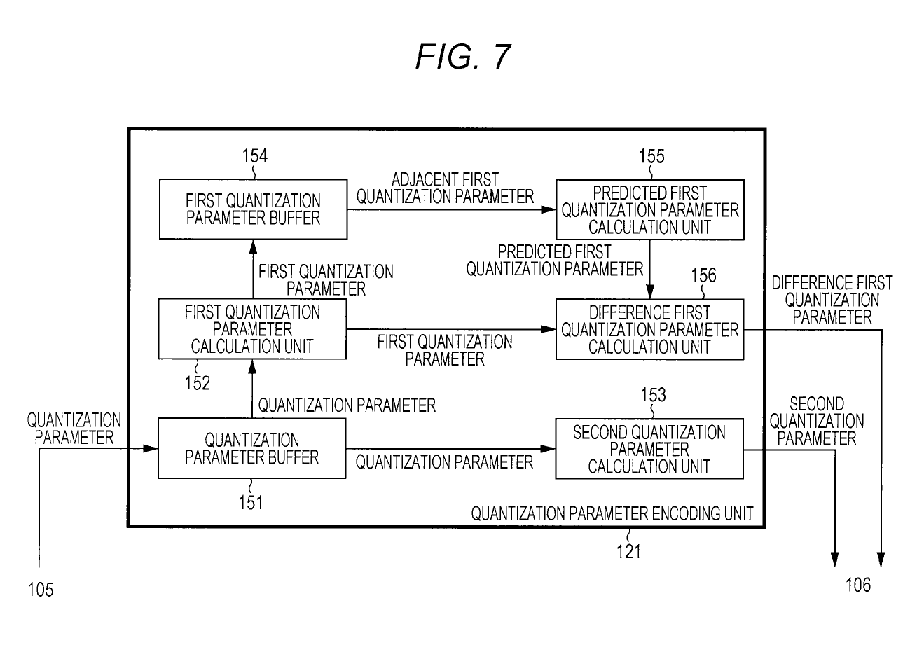

FIG. 7 is a block diagram showing a typical example structure of the quantization parameter encoding unit shown in FIG. 1. As shown in FIG. 7, the quantization parameter encoding unit 121 includes a quantization parameter buffer 151, a first quantization parameter calculation unit 152, a second quantization parameter calculation unit 153, a first quantization parameter buffer 154, a predicted first quantization parameter calculation unit 155, and a difference first quantization parameter calculation unit 156.

The quantization parameter buffer 151 stores a quantization parameter QP supplied from the quantization unit 105. This quantization parameter QP has been used in a quantization process performed by the quantization unit 105, and is of the current CU (the current region) being processed. At a predetermined time or in accordance with a request from outside, the quantization parameter buffer 151 supplies the stored quantization parameter QP of the current CU to the first quantization parameter calculation unit 152 and the second quantization parameter calculation unit 153.

Using the supplied quantization parameter QP, the first quantization parameter calculation unit 152 calculates the first quantization parameter QP₁ as shown in the above equation (4), for example. The first quantization parameter calculation unit 152 supplies the calculated first quantization parameter QP₁ to the first quantization parameter buffer 154 and the difference first quantization parameter calculation unit 156.

Using the supplied quantization parameter QP, the second quantization parameter calculation unit 153 calculates the second quantization parameter QP₂ as shown in the above equation (5), for example. The second quantization parameter calculation unit 153 supplies the calculated second quantization parameter QP₂ to the lossless encoding unit 106, which then multiplexes the second quantization parameter QP₂ with encoded data.

The first quantization parameter buffer 154 stores the supplied first quantization parameter QP₁. In accordance with a request from the predicted first quantization parameter calculation unit 155, the first quantization parameter buffer 154 supplies the first quantization parameter stored therein to the predicted first quantization parameter calculation unit 155.

The predicted first quantization parameter calculation unit 155 predicts the first quantization parameter of the current CU. Using the first quantization parameter of an adjacent CU located adjacent to the current CU (the adjacent first quantization parameter), the predicted first quantization parameter calculation unit 155 predicts the first quantization parameter of the current CU.

First, the predicted first quantization parameter calculation unit 155 selects an adjacent CU. In accordance with the rules shown in the equations (2), for example, the predicted first quantization parameter calculation unit 155 selects the CU (the left CU) adjacent to the left side of the current CU as the adjacent CU if the left CU is available. In a case where the current CU is located at the left edge of the valid pixel region or slice, and therefore, the left CU cannot be referred to (unavailable or non-existent), for example, the predicted first quantization parameter calculation unit 155 selects the CU (the previous CU) processed immediately before the current CU, as the adjacent CU.

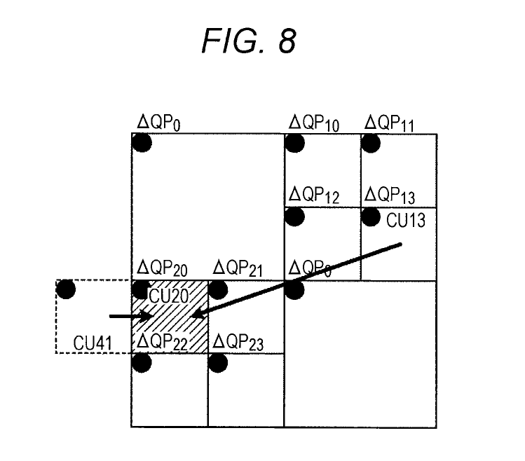

CUs may be arranged in the current LCU being processed as in the example shown in FIG. 8. Where the shaded CU 20 is the current CU, the left CU is the CU 41 of the LCU adjacent to the left side of the current LCU. When the CU 41 is available, the CU 41 is selected as the adjacent CU. If the CU 41 is unavailable (or non-existent), the CU 13 that is the previous CU is selected as the adjacent CU.

The predicted first quantization parameter calculation unit 155 reads, from the first quantization parameter buffer 154, the first quantization parameter (the adjacent first quantization parameter) of the adjacent CU selected in the above described manner. Using the read adjacent first quantization parameter, the predicted first quantization parameter calculation unit 155 predicts the first quantization parameter of the current CU. Specifically, the predicted first quantization parameter calculation unit 155 supplies the read adjacent first quantization parameter as a predicted value (a predicted first quantization parameter) of the first quantization parameter of the current CU, to the difference first quantization parameter calculation unit 156.

The difference first quantization parameter calculation unit 156 calculates a difference value (a difference first quantization parameter) between the first quantization parameter of the current CU supplied from the first quantization parameter calculation unit 152 and the predicted first quantization parameter supplied from the predicted first quantization parameter calculation unit 155.

Specifically, in accordance with the rules shown in the equations (2), when the left CU is available, the difference first quantization parameter calculation unit 156 calculates a difference first quantization parameter between the current CU and the left CU. When the left CU is unavailable, the difference first quantization parameter calculation unit 156 calculates a difference first quantization parameter between the current CU and the previous CU.

The difference first quantization parameter calculation unit 156 supplies the calculated difference first quantization parameter to the lossless encoding unit 106, which then encodes the difference first quantization parameter and multiplexes the encoded difference first quantization parameter with encoded data.

As described above, the quantization parameter encoding unit 121 transforms a quantization parameter into parameters, and then encodes the parameters. Accordingly, the increase in the bit rate can be suppressed. That is, the image encoding device 100 can suppress the decrease in encoding efficiency caused by an increase in quantization accuracy.

[Flow of an Encoding Process]

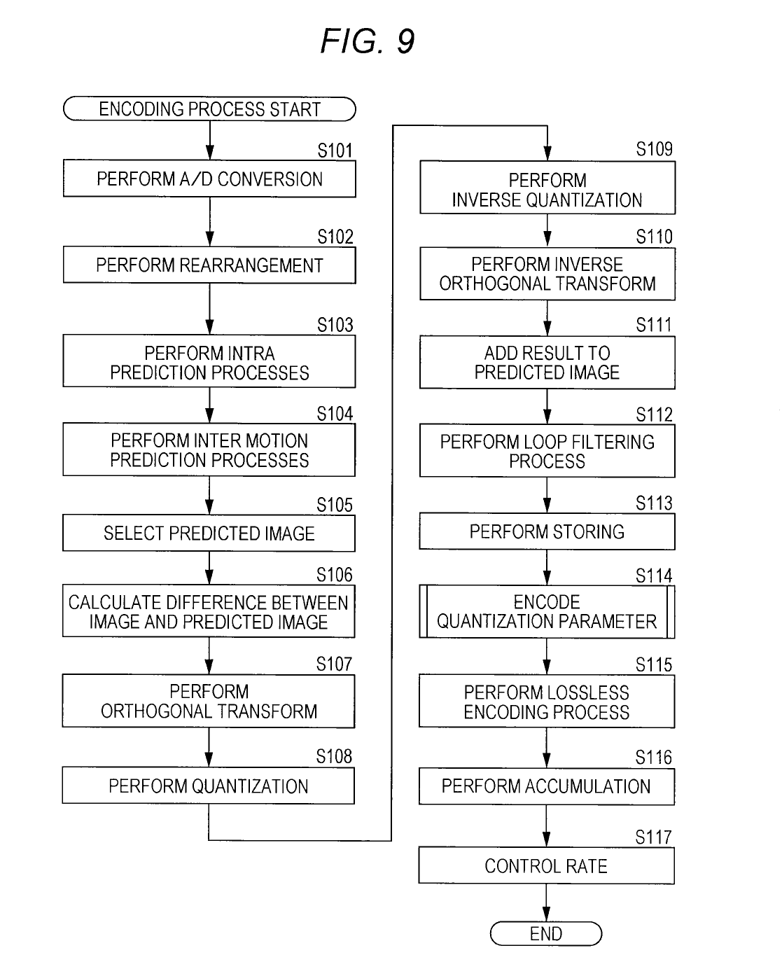

Next, the flow of each process to be performed by the above described image encoding device 100 is described. Referring first to the flowchart shown in FIG. 9, an example flow of an encoding process is described.

In step S101, the A/D converter 101 performs an A/D conversion on an input image. In step S102, the screen rearrangement buffer 102 stores the image subjected to the A/D conversion, and rearranges the respective pictures in encoding order, instead of displaying order.

In step S103, the intra prediction unit 114 performs intra prediction processes in intra prediction modes. In step S104, the motion prediction/compensation unit 115 performs inter motion prediction processes to perform motion predictions and motion compensation in inter prediction modes.

In step S105, the predicted image selection unit 116 determines an optimum prediction mode based on the respective cost function values that are output from the intra prediction unit 114 and the motion prediction/compensation unit 115. That is, the predicted image selection unit 116 selects the predicted image generated by the intra prediction unit 114 or the predicted image generated by the motion prediction/compensation unit 115.

In step S106, the arithmetic operation unit 103 calculates the difference between the image rearranged by the processing in step S102 and the predicted image selected by the processing in step S105. The data amount of the difference data is smaller than that of the original image data. Accordingly, the data amount can be made smaller than in a case where an image is directly encoded.

In step S107, the orthogonal transform unit 104 performs an orthogonal transform on the difference information generated by the processing in step S106. Specifically, an orthogonal transform such as a discrete cosine transform or a Karhunen-Loeve transform is performed, and a transform coefficient is output. In step S108, the quantization unit 105 quantizes the orthogonal transform coefficient obtained by the processing in step S107.

The difference information quantized by the processing in step S108 is locally decoded in the following manner. In step S109, the inverse quantization unit 108 inversely quantizes the orthogonal transform coefficient quantized by the processing in step S108, by a method compatible with the quantization performed in step S108. In step S110, the inverse orthogonal transform unit 109 performs an inverse orthogonal transform on the orthogonal transform coefficient obtained by the processing in step S109, by a method compatible with the processing in step S107.

In step S111, the arithmetic operation unit 110 adds the predicted image to the locally decoded difference information, and generates a locally decoded image (an image corresponding to the input to the arithmetic operation unit 103). In step S112, the loop filter 111 performs filtering on the image generated by the processing in step S111. As a result, block distortion and the like are removed.

In step S113, the frame memory 112 stores the image subjected to the block distortion removal and the like by the processing in step S112. It should be noted that the image that has not been subjected to the filtering process by the loop filter 111 is also supplied from the arithmetic operation unit 110, and is stored into the frame memory 112.

This image stored in the frame memory 112 is used in the processing in step S103 and the processing in step S104.

In step S114, the quantization parameter encoding unit 121 transforms the quantization parameter used in the quantization process in step S108, into parameters.

In step S115, the lossless encoding unit 106 encodes the transform coefficient quantized by the processing in step S108, and generates encoded data. That is, lossless encoding such as variable-length encoding or arithmetic encoding is performed on the difference image (a second-order difference image in the case of an inter prediction).

The lossless encoding unit 106 also encodes the information about the prediction mode of the predicted image selected by the processing in step S105, and adds the encoded information to the encoded data obtained by encoding the difference image. When an intra prediction mode is selected, for example, the lossless encoding unit 106 encodes intra prediction mode information. When an inter prediction mode is selected, for example, the lossless encoding unit 106 encodes inter prediction mode information. The information is added as header information or the like to (or is multiplexed with) the encoded data.

The lossless encoding unit 106 also encodes the quantization-related parameters generated in step S114, as necessary, and adds the encoded quantization-related parameters to (or multiplexes the encoded quantization-related parameters with) the encoded data.

In step S116, the accumulation buffer 107 accumulates the encoded data generated by the processing in step S115. The encoded data accumulated in the accumulation buffer 107 is read out when necessary, and is transmitted to the device on the decoding side via a desired transmission path (including not only a communication channel but also a storage medium or the like).

In step S117, based on the compressed images accumulated in the accumulation buffer 107 by the processing in step S116, the rate control unit 117 controls the quantization operation rate of the quantization unit 105 so as not to cause an overflow or underflow.

When the processing in step S117 is completed, the encoding process comes to an end.

[Flow of the Quantization Parameter Encoding Process]

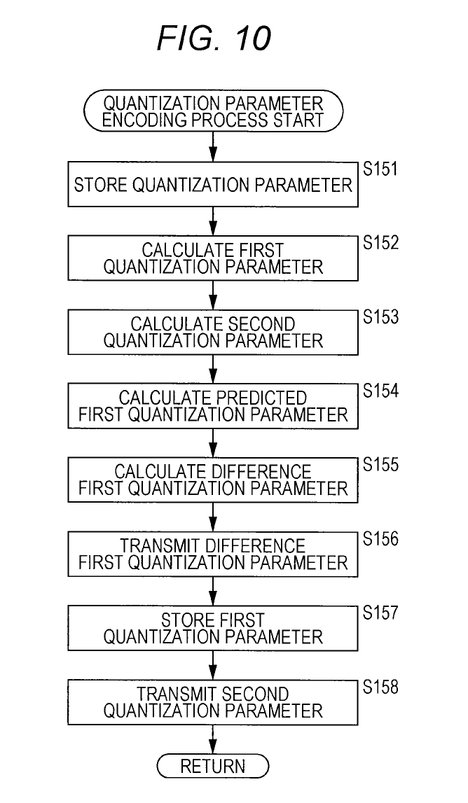

Referring now to the flowchart in FIG. 10, an example of the flow of the quantization parameter encoding process to be performed in step S114 in FIG. 9 is described.

When the quantization parameter encoding process is started, the quantization parameter buffer 151 acquires and stores the quantization parameter used in the quantization process in step S151.

In step S152, the first quantization parameter calculation unit 152 calculates a first quantization parameter from the quantization parameter acquired in step S151, by using the equation (4), for example.

In step S153, the second quantization parameter calculation unit 153 calculates a second quantization parameter from the quantization parameter acquired in step S151, by using the equation (5), for example.

In step S154, the predicted first quantization parameter calculation unit 155 selects an adjacent CU in accordance with the rules shown in the equations (2), for example, and calculates a predicted first quantization parameter by using the first quantization parameter of the adjacent CU.

In step S155, the difference first quantization parameter calculation unit 156 calculates a difference first quantization parameter by using the first quantization parameter calculated in step S152 and the predicted first quantization parameter calculated in step S154.

In step S156, the difference first quantization parameter calculation unit 156 supplies the difference first quantization parameter calculated in step S155 to the lossless encoding unit 106, which then transmits the difference first quantization parameter.

In step S157, the first quantization parameter buffer 154 stores the first quantization parameter calculated in step S152.

In step S158, the second quantization parameter calculation unit 153 supplies the second quantization parameter calculated by the processing in step S153 to the lossless encoding unit 106, which then transmits the second quantization parameter.

When the processing in step S158 is completed, the second quantization parameter calculation unit 153 ends the quantization parameter encoding process, and the process returns to FIG. 9.

By performing the respective processes as described above, the image encoding device 100 can suppress the decrease in encoding efficiency caused by an increase in quantization accuracy.

### 2. Second Embodiment

[Image Decoding Device]

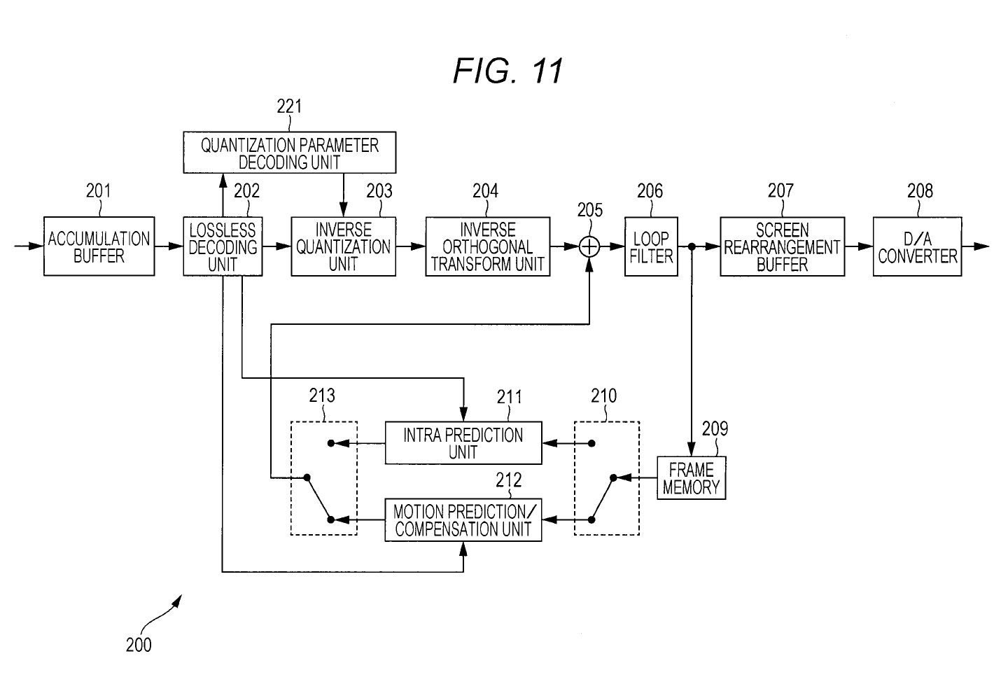

FIG. 11 is a block diagram showing a typical example structure of an image decoding device that is an image processing device to which the present technique is applied. The image decoding device 200 shown in FIG. 11 is compatible with the above described image encoding device 100, and generates a decoded image by correctly decoding a bit stream (encoded data) generated by the image encoding device 100 encoding image data.

As shown in FIG. 11, the image decoding device 200 includes an accumulation buffer 201, a lossless decoding unit 202, an inverse quantization unit 203, an inverse orthogonal transform unit 204, an arithmetic operation unit 205, a loop filter 206, a screen rearrangement buffer 207, and a D/A converter 208. The image decoding device 200 also includes a frame memory 209, a selection unit 210, an intra prediction unit 211, a motion prediction/compensation unit 212, and a selection unit 213.

The image decoding device 200 further includes a quantization parameter decoding unit 221.

The accumulation buffer 201 accumulates encoded data that is transmitted thereto, and supplies the encoded data to the lossless decoding unit 202 at a predetermined time. The lossless decoding unit 202 decodes information that has been encoded by the lossless encoding unit 106 shown in FIG. 1 and has been supplied from the accumulation buffer 201, by a method compatible with the encoding method used by the lossless encoding unit 106. The lossless decoding unit 202 supplies quantized coefficient data of the difference image obtained as a result of the decoding, to the inverse quantization unit 203.

The lossless decoding unit 202 also refers to the information about the optimum prediction mode obtained by decoding the encoded data, and determines whether an intra prediction mode has been selected as the optimum prediction mode and whether an inter prediction mode has been selected as the optimum prediction mode. That is, the lossless decoding unit 202 determines whether the prediction mode used for the transmitted encoded data is an intra prediction mode and whether the prediction mode is an inter prediction mode.

Based on a result of the determination, the lossless decoding unit 202 supplies the information about the prediction mode to the intra prediction unit 211 or the motion prediction/compensation unit 212. In a case where an intra prediction mode has been selected as the optimum prediction mode in the image encoding device 100, for example, the lossless decoding unit 202 supplies intra prediction information that is supplied from the encoding side and relates to the selected intra prediction mode, to the intra prediction unit 211. In a case where an inter prediction mode has been selected as the optimum prediction mode in the image encoding device 100, for example, the lossless decoding unit 202 supplies inter prediction information that is supplied from the encoding side and relates to the selected inter prediction mode, to the motion prediction/compensation unit 212.

The lossless decoding unit 202 further extracts the quantization-related parameters (such as a difference first quantization parameter and a second quantization parameter) added to (multiplexed with) the encoded data, and supplies the quantization-related parameters to the quantization parameter decoding unit 221.

The inverse quantization unit 203 inversely quantizes the quantized coefficient data obtained through the decoding by the lossless decoding unit 202, by a method (the same method as that used by the inverse quantization unit 108) compatible with the quantization method used by the quantization unit 105 shown in FIG. 1. In doing so, the inverse quantization unit 203 performs inverse quantization by using a quantization parameter supplied from the quantization parameter decoding unit 221. The inverse quantization unit 203 supplies the inversely-quantized coefficient data to the inverse orthogonal transform unit 204.

The inverse orthogonal transform unit 204 performs an inverse orthogonal transform on the coefficient data supplied from the inverse quantization unit 203, by a method compatible with the orthogonal transform method used by the orthogonal transform unit 104 shown in FIG. 1. Through this inverse orthogonal transform process, the inverse orthogonal transform unit 204 obtains a difference image corresponding to the difference image not yet subjected to the orthogonal transform in the image encoding device 100.

The difference image obtained through the inverse orthogonal transform is supplied to the arithmetic operation unit 205. A predicted image is also supplied to the arithmetic operation unit 205 from the intra prediction unit 211 or the motion prediction/compensation unit 212 via the selection unit 213.

The arithmetic operation unit 205 adds the difference image to the predicted image, and obtains a reconstructed image corresponding to the image from which the predicted image has not yet been subtracted by the arithmetic operation unit 103 of the image encoding device 100. The arithmetic operation unit 205 supplies the reconstructed image to the loop filter 206.

The loop filter 206 generates a decoded image by performing a loop filtering process including a deblocking filtering process and an adaptive loop filtering process on the supplied reconstructed image as appropriate. For example, the loop filter 206 performs a deblocking filtering process on the reconstructed image, to remove block distortion. Also, the loop filter 206 improves image quality by performing a loop filtering process using a Wiener filter on the result of the deblocking filtering process (the reconstructed image from which block distortion has been removed), for example.

The loop filter 206 can perform any kind of filtering process, and may perform a filtering process other than the above described ones. The loop filter 206 may also perform a filtering process by using the filter coefficient supplied from the image encoding device 100 shown in FIG. 1.

The loop filter 206 supplies the decoded image as the result of the filtering process to the screen rearrangement buffer 207 and the frame memory 209. The filtering process by the loop filter 206 can be skipped. That is, the output of the arithmetic operation unit 205 may not be subjected to any filtering process, and be stored directly into the frame memory 209. The intra prediction unit 211 uses the pixel value of a pixel included in this image as the pixel value of an adjacent pixel.

The screen rearrangement buffer 207 performs rearrangement on the supplied decoded image. Specifically, the frame sequence rearranged in the encoding order by the screen rearrangement buffer 102 shown in FIG. 1 is rearranged in the original displaying order. The D/A converter 208 performs a D/A conversion on the decoded image supplied from the screen rearrangement buffer 207, and outputs the decoded image to a display (not shown) to display the image.

The frame memory 209 stores the supplied reconstructed image and the supplied decoded image. At a predetermined time or in accordance with a request from outside such as from the intra prediction unit 211 or the motion prediction/compensation unit 212, the frame memory 209 supplies the stored reconstructed image or the stored decoded image to the intra prediction unit 211 or the motion prediction/compensation unit 212 via the selection unit 210.

The intra prediction unit 211 performs processes that are basically the same as those performed by the intra prediction unit 114 shown in FIG. 1. However, the intra prediction unit 211 performs intra predictions only on the regions where predicted images have been generated through intra predictions at the time of encoding.

The motion prediction/compensation unit 212 performs inter predictions (including motion predictions and motion compensation) based on the inter prediction information supplied from the lossless decoding unit 202, and generates predicted images. Based on the inter prediction information supplied from the lossless decoding unit 202, the motion prediction/compensation unit 212 performs inter predictions only on the regions where inter predictions have been performed at the time of encoding.

For each prediction processing unit region, the intra prediction unit 211 or the motion prediction/compensation unit 212 supplies a generated predicted image to the arithmetic operation unit 205 via the selection unit 213.

The selection unit 213 supplies a predicted image supplied from the intra prediction unit 211 or a predicted image supplied from the motion prediction/compensation unit 212, to the arithmetic operation unit 205.

The quantization parameter decoding unit 221 acquires the quantization-related parameters supplied from the lossless decoding unit 202. The quantization-related parameters have been added to a bit stream and been supplied from the device on the encoding side, and have been generated by transforming the quantization parameter used in the quantization process performed at the time of encoding. Using the quantization-related parameters, the quantization parameter decoding unit 221 reconstructs the quantization parameter used in the quantization process.

For example, the image encoding device 100 as the device on the encoding side has transformed a quantization parameter QP into a first quantization parameter QP₁ and a second quantization parameter QP₂, as shown in the above described equations (4) and (5). The image encoding device 100 has then transferred a bit stream to which the encoded data of a difference first quantization parameter generated from the first quantization parameter QP₁ and the second quantization parameter QP₂ have been added, to the image decoding device 200.

The lossless decoding unit 202 extracts the encoded difference first quantization parameter and the second quantization parameter QP₂ from the bit stream. The lossless decoding unit 202 decodes the difference first quantization parameter, and supplies the result of the decoding and the second quantization parameter to the quantization parameter decoding unit 221.

The quantization parameter decoding unit 221 calculates the first quantization parameter QP₁ from the difference first quantization parameter, and reconstructs the quantization parameter QP by using the first quantization parameter QP₁ and the second quantization parameter QP₂ as shown in the following equation (6).

QP=2×QP₁+QP₂ (6)

By doing so, the quantization parameter decoding unit 221 can correctly reconstruct the quantization parameter used in the quantization process. The quantization parameter decoding unit 221 supplies the reconstructed quantization parameter to the inverse quantization unit 203.

As a result, the inverse quantization unit 203 can perform inverse quantization by a method compatible with the quantization process performed by the quantization unit 105.

Accordingly, the image decoding device 200 can suppress the decrease in encoding efficiency.

The calculation (2×QP₁) in the above equation (6) can be realized by a shift operation. Thus, the image decoding device 200 can readily reconstruct the quantization parameter (and can suppress the increase in calculation load caused by this reconstruction).

[Quantization Parameter Decoding Unit]

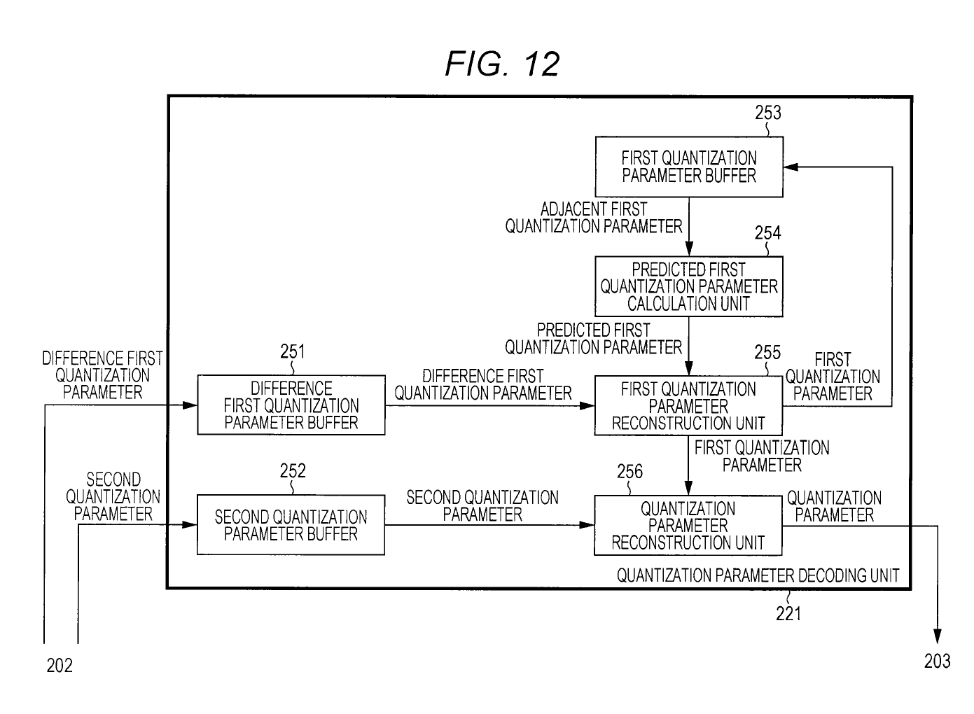

FIG. 12 is a block diagram showing a typical example structure of the quantization parameter decoding unit 221. As shown in FIG. 12, the quantization parameter decoding unit 221 includes a difference first quantization parameter buffer 251, a second quantization parameter buffer 252, a first quantization parameter buffer 253, a predicted first quantization parameter calculation unit 254, a first quantization parameter reconstruction unit 255, and a quantization parameter reconstruction unit 256.

The difference first quantization parameter buffer 251 acquires and stores a difference first quantization parameter supplied from the lossless decoding unit 202. At a predetermined time or in accordance with a request from another processor, the difference first quantization parameter buffer 251 supplies the stored difference first quantization parameter to the first quantization parameter reconstruction unit 255.

The second quantization parameter buffer 252 acquires and stores a second quantization parameter QP₂ supplied from the lossless decoding unit 202. At a predetermined time or in accordance with a request from another processor, the second quantization parameter buffer 252 supplies the stored second quantization parameter QP₂ to the first quantization parameter reconstruction unit 255.

The first quantization parameter buffer 253 acquires and stores a first quantization parameter QP₁ supplied from the first quantization parameter reconstruction unit 255. In processing of another CU, at a predetermined time or in accordance with a request from another processor, the first quantization parameter buffer 253 supplies the stored first quantization parameter QP₁ as the first quantization parameter of an adjacent CU (an adjacent first quantization parameter) to the predicted first quantization parameter calculation unit 254.

The predicted first quantization parameter calculation unit 254 identifies the CU that is the adjacent CU, acquires the first quantization parameter of the adjacent CU from the first quantization parameter buffer 253, and supplies the acquired first quantization parameter as a predicted first quantization parameter to the first quantization parameter reconstruction unit 255.

As described above in the first embodiment, the difference first quantization parameter is the difference value between the first quantization parameter of the current CU and the first quantization parameter of the adjacent CU. As shown in the equations (2), either the left CU or the previous CU is selected as the adjacent CU.

In view of this, the predicted first quantization parameter calculation unit 254 determines whether the left CU is available, as shown in the equations (2). When the left CU is available, the predicted first quantization parameter calculation unit 254 sets the left CU as the adjacent CU, and reads the first quantization parameter QP₁ of the left CU as the adjacent first quantization parameter from the first quantization parameter buffer 253.

When the left CU is unavailable, the predicted first quantization parameter calculation unit 254 sets the previous CU as the adjacent CU, and reads the first quantization parameter QP₁ of the previous CU as the adjacent first quantization parameter from the first quantization parameter buffer 253.

The predicted first quantization parameter calculation unit 254 supplies the adjacent first quantization parameter acquired in the above described manner as a predicted value (a predicted first quantization parameter) of the first quantization parameter of the current CU, to the first quantization parameter reconstruction unit 255.

The first quantization parameter reconstruction unit 255 acquires the difference first quantization parameter of the current CU from the difference first quantization parameter buffer 251, and also acquires the predicted first quantization parameter of the current CU from the predicted first quantization parameter calculation unit 254. Using those parameters, the first quantization parameter reconstruction unit 255 reconstructs the first quantization parameter QP₁ by a method according to the equations (2). Specifically, the first quantization parameter reconstruction unit 255 reconstructs the first quantization parameter QP₁ by adding the predicted first quantization parameter to the difference first quantization parameter. The first quantization parameter reconstruction unit 255 supplies the reconstructed first quantization parameter QP₁ to the quantization parameter reconstruction unit 256.

The quantization parameter reconstruction unit 256 acquires the first quantization parameter QP₁ of the current CU from the first quantization parameter reconstruction unit 255, and also acquires the second quantization parameter QP₂ of the current CU from the second quantization parameter buffer 252. Using those parameters, the quantization parameter reconstruction unit 256 reconstructs the quantization parameter QP of the current CU, as shown in the above described equation (6). The quantization parameter reconstruction unit 256 supplies the reconstructed quantization parameter QP of the current CU to the inverse quantization unit 203.

Using the quantization parameter QP, the inverse quantization unit 203 inversely quantizes the coefficient data of the current CU.

As described above, the quantization parameter decoding unit 221 reconstructs a quantization parameter from quantization-related parameters, and then performs inverse quantization, so that an increase in the bit rate of the parameters to be transmitted can be suppressed. Accordingly, the image decoding device 200 can suppress the decrease in encoding efficiency caused by an increase in quantization accuracy.

[Flow of a Decoding Process]

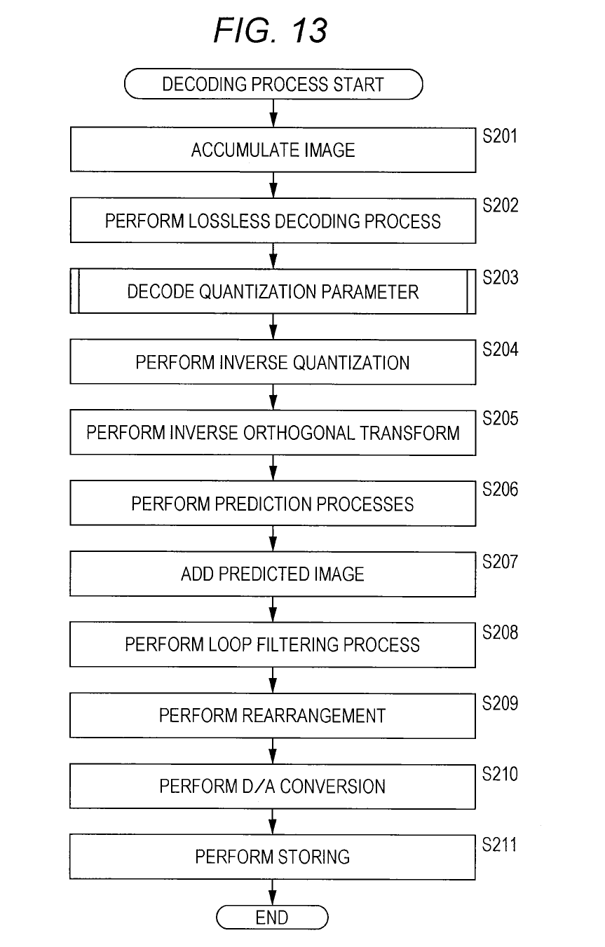

Next, the flow of each process to be performed by the above described image decoding device 200 is described. Referring first to the flowchart shown in FIG. 13, an example flow of a decoding process is described.

When the decoding operation is started, the accumulation buffer 201 accumulates transmitted encoded data in step 5201. In step S202, the lossless decoding unit 202 decodes the encoded data supplied from the accumulation buffer 201. Specifically, I-pictures, P-pictures, and B-pictures encoded by the lossless encoding unit 106 shown in FIG. 1 are decoded.

At this point, motion vector information, reference frame information, prediction mode information (an intra prediction mode or an inter prediction mode), and information about quantization-related parameters are also decoded.

In step S203, the quantization parameter decoding unit 221 reconstructs a quantization parameter by using the quantization-related parameters.

In step S204, using the quantization parameter reconstructed by the processing in step S203, the inverse quantization unit 203 inversely quantizes the quantized orthogonal transform coefficient obtained by the processing in step S202.

In step S205, the inverse orthogonal transform unit 204 performs an inverse orthogonal transform on the orthogonal transform coefficient obtained through the inverse quantization performed by the inverse quantization unit 203, by a method compatible with the method used by the orthogonal transform unit 104 shown in FIG. 1. As a result, the difference information corresponding to the input to the orthogonal transform unit 104 (or the output from the arithmetic operation unit 103) shown in FIG. 1 is decoded.

In step S206, the intra prediction unit 211 or the motion prediction/compensation unit 212 performs image prediction processes in accordance with the prediction mode information supplied from the lossless decoding unit 202. Specifically, in a case where intra prediction mode information is supplied from the lossless decoding unit 202, the intra prediction unit 211 performs intra prediction processes in intra prediction modes. In a case where inter prediction mode information is supplied from the lossless decoding unit 202, the motion prediction/compensation unit 212 performs inter prediction processes (including motion predictions and motion compensation) by using the various kinds of information about unit size obtained by the processing in step S203.

In step S207, the arithmetic operation unit 205 adds the predicted image obtained by the processing in step S206 to the difference information obtained by the processing in step S204. In this manner, the original image data is decoded.

In step S208, the loop filter 206 performs a loop filtering process including a deblocking filtering process and an adaptive loop filtering process on the reconstructed image obtained by the processing in step S207, where appropriate.

In step S209, the screen rearrangement buffer 207 rearranges the frames of the decoded image data. Specifically, in the decoded image data, the order of frames rearranged for encoding by the screen rearrangement buffer 102 of the image encoding device 100 (FIG. 1) is rearranged in the original displaying order.

In step S210, the D/A converter 208 performs a D/A conversion on the decoded image data having the frames rearranged by the screen rearrangement buffer 207. The decoded image data is output to a display (not shown), and the image is displayed.

In step S211, the frame memory 209 stores the decoded images subjected to the filtering by the processing in step S208.

[Flow of the Quantization Parameter Decoding Process]

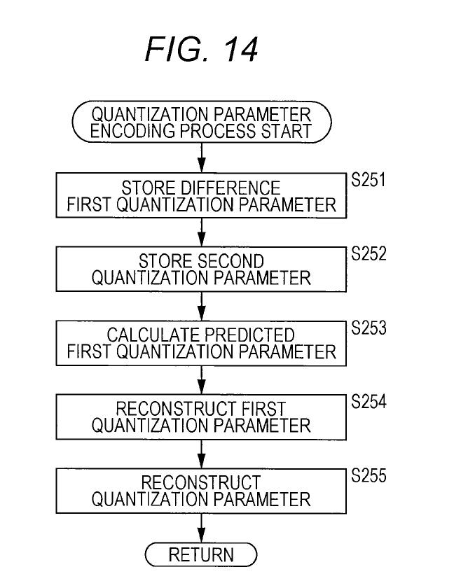

Referring now to the flowchart shown in FIG. 14, an example flow of the quantization parameter decoding process to be performed in step S203 in FIG. 13 is described.

When the quantization parameter decoding process is started, the difference first quantization parameter buffer 251 in step S251 acquires and stores the difference first quantization parameter decoded in step S202.

In step S252, the second quantization parameter buffer 252 acquires and stores the second quantization parameter decoded in step S202.

In step S253, the predicted first quantization parameter calculation unit 254 identifies the adjacent CU for the current CU based on the position and the like of the current CU, and calculates a predicted first quantization parameter of the current CU by using the first quantization parameter of the adjacent CU.

In step S254, the first quantization parameter reconstruction unit 255 reconstructs the first quantization parameter by using the difference first quantization parameter of the current CU acquired in step S251 and the predicted first quantization parameter calculated in step S253. The reconstructed first quantization parameter is then supplied and stored into the first quantization parameter buffer.

In step S255, the quantization parameter reconstruction unit 256 reconstructs the quantization parameter of the current CU by using the second quantization parameter of the current CU acquired in step S252 and the first quantization parameter of the current CU reconstructed in step S254.

After reconstructing the quantization parameter, the quantization parameter reconstruction unit 256 ends the quantization parameter decoding process, and the process returns to FIG. 13.

By performing the respective processes as described above, the image decoding device 200 can suppress the decrease in encoding efficiency caused by an increase in quantization accuracy.

In the above embodiments, a quantization parameter is transformed into two parameters. However, a quantization parameter may be transformed into any parameters, as long as the bit rate can be made lower than that in a case where a quantization parameter after redefinition is encoded as it is. That is, the parameters after the transform may be parameters other than the above described ones, and the number of the parameters after the trans form may be three or greater.

Also, candidates for the adjacent CU are not limited to the left CU and the previous CU. Any CU other than the current CU may be used as the adjacent CU. However, to reduce first quantization parameter prediction error, the adjacent CU is preferably a CU that is located closer to the current CU than other CUs. The number of candidate CUs may also be arbitrarily set. Furthermore, the method to select one CU from the candidates may be any appropriate method and is not limited to the above described examples. Also, a predicted first quantization parameter may not be the first quantization parameter of the adjacent CU as described above, but may be calculated through a predetermined arithmetic operation using the first quantization parameter(s) of one or more CUs.

### 3. Third Embodiment

[Computer]

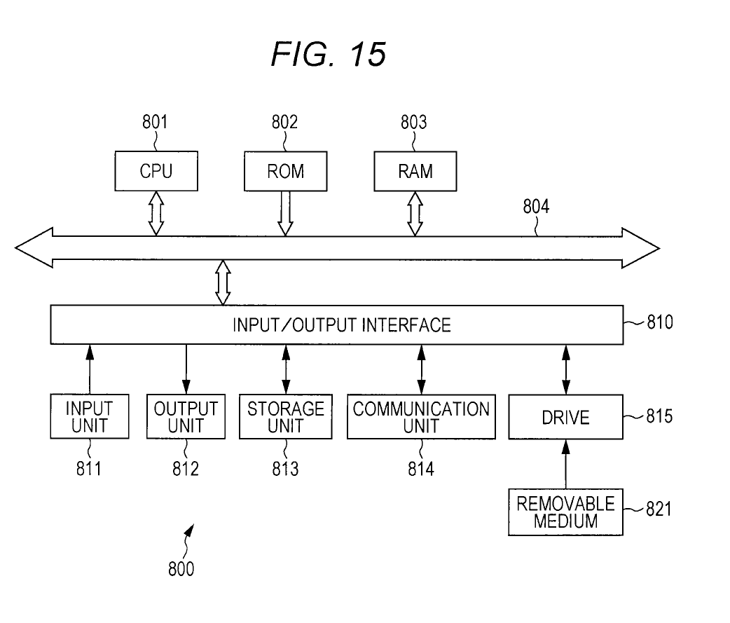

The above described series of processes can be performed by hardware or can be performed by software. In this case, the processes may be realized by a computer as shown in FIG. 15, for example.

In FIG. 15, the CPU (Central Processing Unit) 801 of a computer 800 performs various kinds of processes in accordance with a program stored in a ROM (Read Only Memory) 802, or a program loaded from a storage unit 813 into a RAM (Random Access Memory) 803. The RAM 803 also stores data necessary for the CPU 801 to perform various processes and the like as necessary.

The CPU 801, the ROM 802, and the RAM 803 are connected to one another via a bus 804. An input/output interface 810 is also connected to the bus 804.

The following components are also connected to the input/output interface 810: an input unit 811 formed with a keyboard, a mouse, a touch panel, an input terminal, or the like; an output unit 812 formed with output devices or output terminals including a display such as a CRT (Cathode Ray Tube), an LCD (Liquid Crystal Display), or an OELD (Organic Electro Luminescence Display), and a speaker; a storage unit 813 formed with a storage medium such as a hard disk or a flash memory, and a control unit or the like that controls inputs and outputs of the storage medium; and a communication unit 814 formed with a wired or wireless communication device such as a modem, a LAN interface, a USB (Universal Serial Bus), or Bluetooth (a registered trade name). The communication unit 814 performs communications with other communication devices via networks including the Internet, for example.

A drive 815 is also connected to the input/output interface 810, if necessary. A removable medium 821 such as a magnetic disk, an optical disk, a magnetooptical disk, or a semiconductor memory is mounted on the drive 815, as appropriate. Under the control of the CPU 801, for example, the drive 815 reads computer programs, data, and the like from the removable medium 821 mounted thereon. The read data and the read computer programs are supplied to the RAM 803, for example. The computer programs that have been read from the removable medium 821 are installed into the storage unit 813 as necessary.

When the above described series of processes are performed by software, the programs constituting the software are installed from a network or a recording medium.

As shown in FIG. 15, examples of the recording medium include the removable medium 821 that is distributed for delivering programs to users separately from the device, such as a magnetic disk (including a flexible disk), an optical disk (including a CD-ROM (compact disc-read only memory) or a DVD (digital versatile disc)), a magnetooptical disk (including an MD (mini disc)), and a semiconductor memory, which has programs recorded thereon, and alternatively, the ROM 802 having programs recorded therein and a hard disk included in the storage unit 813, which are incorporated beforehand into the device prior to delivery to users.

The programs to be executed by the computer may be programs for performing processes in chronological order in accordance with the sequence described in this specification, or may be programs for performing processes in parallel or performing a process when necessary, such as when there is a call.

In this specification, steps describing programs to be recorded in a recording medium include processes to be performed in parallel or independently of one another if not necessarily in chronological order, as well as processes to be performed in chronological order in accordance with the sequence described herein.

In this specification, a “system” means an entire apparatus formed with two or more devices (apparatuses).

Also, in the above described examples, any structure described as one device (or one processing unit) may be divided into two or more devices (or processing units). Conversely, any structure described as two or more devices (or processing units) may be combined to form one device (or one processing unit). Also, it is of course possible to add a structure other than the above described ones to the structure of any of the devices (or any of the processing units). Further, as long as the structure and function of the entire system remain the same, part of the structure of a device (or a processing unit) may be incorporated into another device (or another processing unit). That is, embodiments of the present technique are not limited to the above described embodiments, and various modifications may be made to them without departing from the scope of the technique.

The image encoding device 100 (FIG. 1) and the image decoding device 200 (FIG. 11) according to the above described embodiments can be applied to various electronic apparatuses including: transmitters and receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing apparatuses that reproduce images from those storage media. Four examples of applications will be described below.

### 4. Fourth Embodiment

[Television Apparatus]

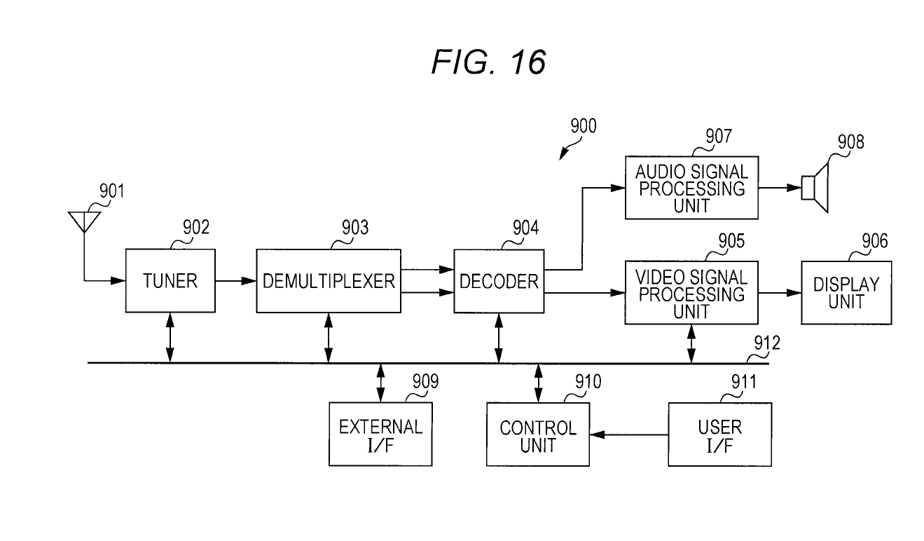

FIG. 16 schematically shows an example structure of a television apparatus to which the above described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from broadcast signals received via the antenna 901, and demodulates the extracted signal. The tuner 902 outputs the encoded bit stream obtained by the demodulation to the demultiplexer 903. That is, the tuner 902 serves as a transmission unit in the television apparatus 900 that receives an encoded stream of encoded images.

The demultiplexer 903 separates the video stream and the audio stream of a show to be viewed from the encoded bit stream, and outputs the respective separated streams to the decoder 904. The demultiplexer 903 also extracts auxiliary data such as an EPG (Electronic Program Guide) from the encoded bit stream, and supplies the extracted data to the control unit 910. In a case where the encoded bit stream has been scrambled, the demultiplexer 903 may perform descrambling.

The decoder 904 decodes the video stream and the audio stream input from the demultiplexer 903. The decoder 904 then outputs video data generated by the decoding to the video signal processing unit 905. The decoder 904 also outputs audio data generated by the decoding to the audio signal processing unit 907.

The video signal processing unit 905 reproduces the video data input from the decoder 904, and causes the display unit 906 to display the video image. Also, the video signal processing unit 905 may cause the display unit 906 to display an application screen supplied via a network. Also, the video signal processing unit 905 may perform additional processing such as denoising on the video data in accordance with the settings. Further, the video signal processing unit 905 may generate an image of a GUI (Graphical User Interface) such as a menu and buttons or a cursor, and superimpose the generated image on an output image.

The display unit 906 is driven by a drive signal supplied from the video signal processing unit 905, and displays a video image or an image on the video screen of a display device (such as a liquid crystal display, a plasma display, or an OELD (Organic ElectroLuminescence Display)).

The audio signal processing unit 907 performs a reproduction process such as a D/A conversion and amplification on the audio data input from the decoder 904, and outputs sound from the speaker 908. Also, the audio signal processing unit 907 may perform additional processing such as denoising on the audio data.

The external interface 909 is an interface for connecting the television apparatus 900 to an external device or a network. For example, a video stream or an audio stream received via the external interface 909 may be decoded by the decoder 904. That is, the external interface 909 also serves as a transmission unit in the television apparatus 900 that receives an encoded stream of encoded images.

The control unit 910 includes a processor such as a CPU, and a memory such as a RAM or a ROM. The memory stores the program to be executed by the CPU, program data, EPG data, data acquired via networks, and the like. The program stored in the memory is read by the CPU at the time of activation of the television apparatus 900, for example, and is then executed. By executing the program, the CPU controls operations of the television apparatus 900 in accordance with an operating signal input from the user interface 911, for example.

The user interface 911 is connected to the control unit 910. The user interface 911 includes buttons and switches for the user to operate the television apparatus 900, and a reception unit for remote control signals, for example. The user interface 911 generates an operating signal by detecting an operation by the user via those components, and outputs the generated operating signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 having the above described structure, the decoder 904 has the functions of the image decoding device 200 (FIG. 11) according to the above described embodiments. Accordingly, the decoder 904 can correctly decode and reconstruct a quantization parameter that has been transformed into parameters and been encoded, and can perform an inverse quantization process by using the quantization parameter. Thus, the television apparatus 900 can suppress the decrease in encoding efficiency caused by an increase in quantization accuracy.

### 5. Fifth Embodiment

[Portable Telephone Device]

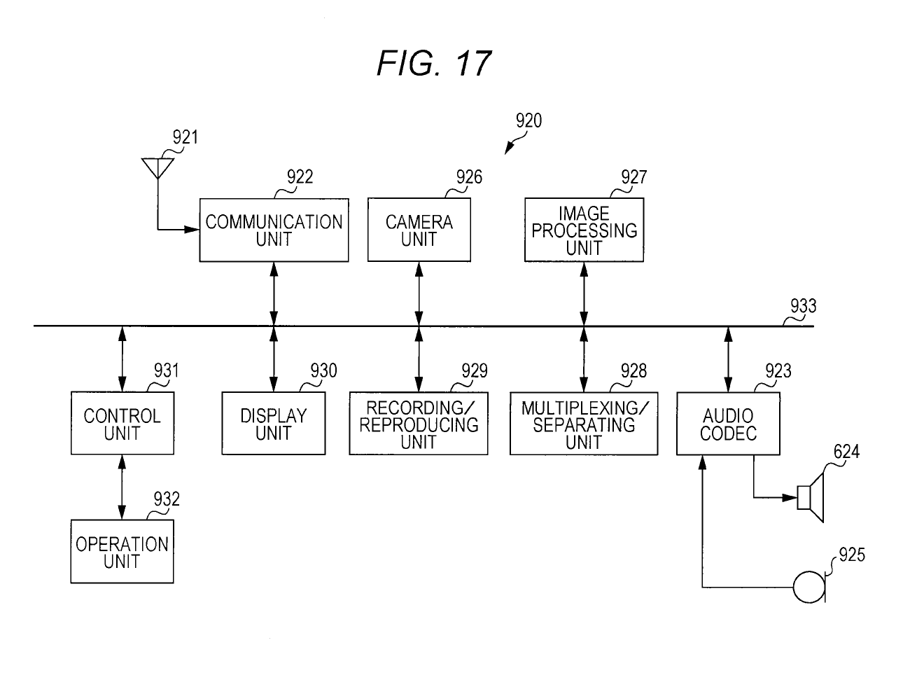

FIG. 17 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 920 performs operations such as transmission and reception of audio signals, transmission and reception of electronic mail or image data, imaging operations, and data recording in various operation modes including an audio communication mode, a data communication mode, an imaging mode, and a video phone mode.

In the audio communication mode, an analog audio signal generated by the microphone 925 is supplied to the audio codec 923. The audio codec 923 converts the analog audio signal to audio data, and performs compression and an A/D conversion on the converted audio data. The audio codec 923 outputs the compressed audio data to the communication unit 922. The communication unit 922 encodes and modulates the audio data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 generates audio data by demodulating and decoding the reception signal, and outputs the generated audio data to the audio codec 923. The audio codec 923 performs decompression and a D/A conversion on the audio data, to generate an analog audio signal. The audio codec 923 then outputs the generated audio signal to the speaker 924 to output sound.

In the data communication mode, the control unit 931 generates text data constituting an electronic mail in accordance with an operation by the user via the operation unit 932. The control unit 931 causes the display unit 930 to display the text. The control unit 931 also generates electronic mail data in accordance with a transmission instruction from the user via the operation unit 932, and outputs the generated electronic mail data to the communication unit 922. The communication unit 922 encodes and modulates the electronic mail data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 then restores the electronic mail data by demodulating and decoding the reception signal, and outputs the restored electronic mail data to the control unit 931. The control unit 931 causes the display unit 930 to display the contents of the electronic mail, and stores the electronic mail data into the storage medium in the recording/reproducing unit 929.

The recording/reproducing unit 929 includes a readable/rewritable storage medium. For example, the storage medium may be an internal storage medium such as a RAM or a flash memory, or may be a storage medium of an externally mounted type such as a hard disk, a magnetic disk, a magnetooptical disk, an optical disk, a USB memory, or a memory card.

In the imaging mode, the camera unit 926 generates image data by capturing an image of an object, and outputs the generated image data to the image processing unit 927. The image processing unit 927 encodes the image data input from the camera unit 926, and stores the encoded stream into the storage medium in the recording/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The transmission signal and the reception signal may include an encoded bit stream. The communication unit 922 restores a stream by demodulating and decoding the reception signal, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream, to generate video data. The video data is supplied to the display unit 930, and a series of images are displayed by the display unit 930. The audio codec 923 performs decompression and a D/A conversion on the audio stream, to generate an analog audio signal. The audio codec 923 then outputs the generated audio signal to the speaker 924 to output sound.

In the portable telephone device 920 having the above described structure, the image processing unit 927 has the functions of the image encoding device 100 (FIG. 1) and the functions of the image decoding device 200 (FIG. 11) according to the above described embodiments. Accordingly, for an image to be encoded and decoded in the portable telephone device 920, the image processing unit 927 can transform the quantization parameter used in quantization into parameters, encode the parameters, correctly reconstruct the quantization parameter by decoding the parameters, and perform an inverse quantization process by using the quantization parameter. Thus, the portable telephone device 920 can suppress the decrease in encoding efficiency caused by an increase in quantization accuracy.

Although the portable telephone device 920 has been described above, an image encoding device and an image decoding device to which the present technique is applied can also be used in any device in the same manner as in the case with the portable telephone device 920, as long as the device has the same image capturing function and the same communication function as the portable telephone 920. Such a device may be a PDA (Personal Digital Assistant), a smartphone, an UMPC (Ultra Mobile Personal Computer), a netbook, or a notebook personal computer, for example.

### 6. Sixth Embodiment

[Recording/Reproducing Apparatus]

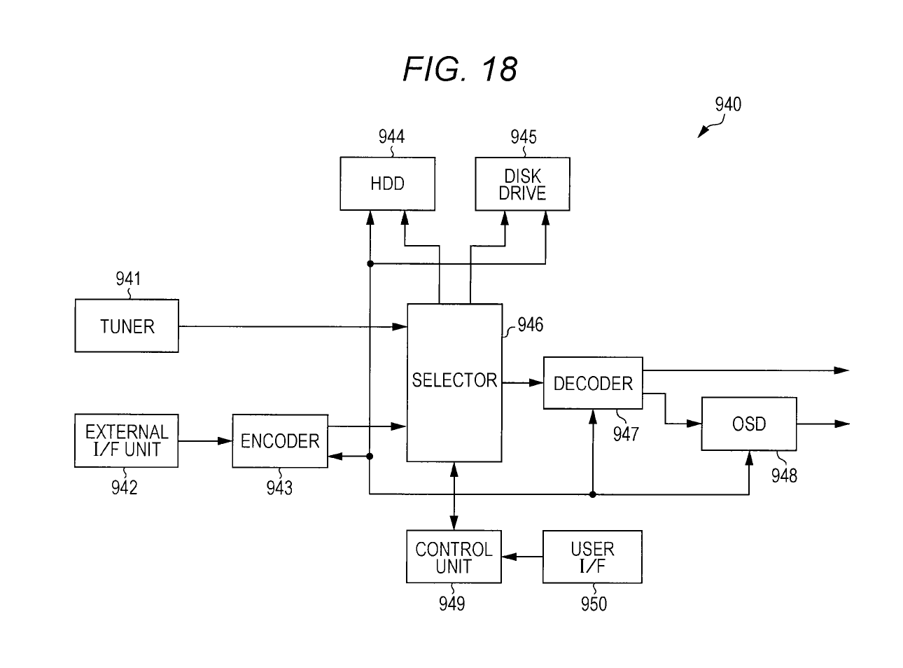

FIG. 18 schematically shows an example structure of a recording/reproducing apparatus to which the above described embodiments are applied. A recording/reproducing apparatus 940 encodes audio data and video data of a received broadcast show, for example, and records the audio data and the video data on a recording medium. The recording/reproducing apparatus 940 may encode audio data and video data acquired from another apparatus, for example, and record the audio data and the video data on the recording medium. The recording/reproducing apparatus 940 also reproduces data recorded on the recording medium through a monitor and a speaker in accordance with an instruction from the user, for example. In doing so, the recording/reproducing apparatus 940 decodes audio data and video data.

The recording/reproducing apparatus 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from broadcast signals received via an antenna (not shown), and demodulates the extracted signal. The tuner 941 outputs the encoded bit stream obtained by the demodulation to the selector 946. That is, the tuner 941 serves as a transmission unit in the recording/reproducing apparatus 940.

The external interface 942 is an interface for connecting the recording/reproducing apparatus 940 to an external device or a network. The external interface 942 may be an IEEE1394 interface, a network interface, a USB interface, or a flash memory interface, for example. Video data and audio data received via the external interface 942 are input to the encoder 943, for example. That is, the external interface 942 serves as a transmission unit in the recording/reproducing apparatus 940.

In a case where video data and audio data input from the external interface 942 have not been encoded, the encoder 943 encodes the video data and the audio data. The encoder 943 then outputs an encoded bit stream to the selector 946.

The HDD 944 records an encoded bit stream formed with compressed content data such as video images and sound, various programs, and other data on an internal hard disk. At the time of reproduction of video images and sound, the HDD 944 reads those data from the hard disk.

The disk drive 945 records data on and reads data from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (a registered trade name) disk, for example.

At the time of recording of video images and sound, the selector 946 selects an encoded bit stream input from the tuner 941 or the encoder 943, and outputs the selected encoded bit stream to the HDD 944 or the disk drive 945. At the time of reproduction of video images and sound, the selector 946 also outputs an encoded bit stream input from the HDD 944 or the disk drive 945, to the decoder 947.

The decoder 947 decodes the encoded bit stream, and generates video data and audio data. The decoder 947 outputs the generated video data to the OSD 948. The decoder 904 also outputs the generated audio data to an external speaker.

The OSD 948 reproduces the video data input from the decoder 947, and displays video images. The OSD 948 may superimpose an image of a GUI such as a menu and buttons or a cursor on the video images to be displayed.

The control unit 949 includes a processor such as a CPU, and a memory such as a RAM or a ROM. The memory stores the program to be executed by the CPU, program data, and the like. The program stored in the memory is read by the CPU at the time of activation of the recording/reproducing apparatus 940, for example, and is then executed. By executing the program, the CPU controls operations of the recording/reproducing apparatus 940 in accordance with an operating signal input from the user interface 950, for example.

The user interface 950 is connected to the control unit 949. The user interface 950 includes buttons and switches for the user to operate the recording/reproducing apparatus 940, and a reception unit for remote control signals, for example. The user interface 950 generates an operating signal by detecting an operation by the user via those components, and outputs the generated operating signal to the control unit 949.

In the recording/reproducing apparatus 940 having the above described structure, the encoder 943 has the functions of the image encoding device 100 (FIG. 1) according to the above described embodiments. Also, the decoder 947 has the functions of the image decoding device 200 (FIG. 11) according to the above described embodiments. Accordingly, for an image to be encoded and decoded in the recording/reproducing apparatus 940, the encoder 943 and the decoder 947 can transform the quantization parameter used in quantization into parameters, encode the parameters, correctly reconstruct the quantization parameter by decoding the parameters, and perform an inverse quantization process by using the quantization parameter. Thus, the recording/reproducing apparatus 940 can suppress the decrease in encoding efficiency caused by an increase in quantization accuracy.

### 7. Seventh Embodiment

[Imaging Apparatus]

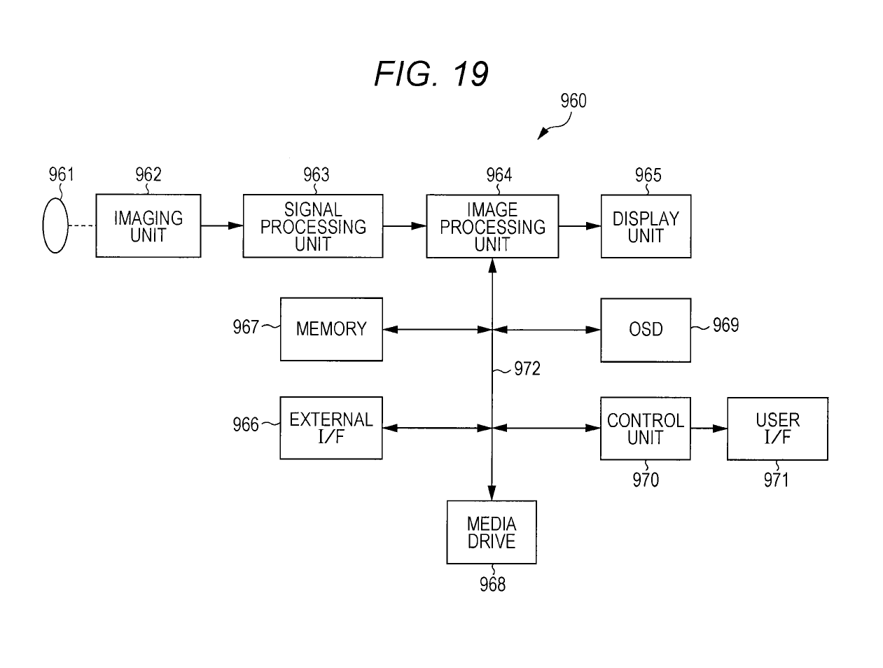

FIG. 19 schematically shows an example structure of an imaging apparatus to which the above described embodiments are applied. An imaging apparatus 960 generates images by imaging an object, encodes the image data, and records the image data on a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to one another.

The optical block 961 includes a focus lens and a diaphragm. The optical block 961 forms an optical image of an object on the imaging surface of the imaging unit 962. The imaging unit 962 includes an image sensor such as a CCD or a CMOS, and converts the optical image formed on the imaging surface into an image signal as an electrical signal through a photoelectric conversion. The imaging unit 962 outputs the image signal to the signal processing unit 963.

The signal processing unit 963 performs various kinds of camera signal processing such as knee correction, gamma correction, and color correction on the image signal input from the imaging unit 962. The signal processing unit 963 outputs the image data subjected to the camera signal processing to the image processing unit 964.

The image processing unit 964 encodes the image data input from the signal processing unit 963, and generates encoded data. The image processing unit 964 outputs the generated encoded data to the external interface 966 or the media drive 968. The image processing unit 964 also decodes encoded data input from the external interface 966 or the media drive 968, and generates image data. The image processing unit 964 outputs the generated image data to the display unit 965. Alternatively, the image processing unit 964 may output the image data input from the signal processing unit 963 to the display unit 965 to display images. The image processing unit 964 may also superimpose display data acquired from the OSD 969 on the images to be output to the display unit 965.

The OSD 969 generates an image of a GUI such as a menu and buttons or a cursor, for example, and outputs the generated image to the image processing unit 964.

The external interface 966 is formed as a USB input/output terminal, for example. The external interface 966 connects the imaging apparatus 960 to a printer at the time of printing of an image, for example. A drive is also connected to the external interface 966, if necessary. A removable medium such as a magnetic disk or an optical disk is mounted on the drive so that a program read from the removable medium can be installed into the imaging apparatus 960. Further, the external interface 966 may be designed as a network interface to be connected to a network such as a LAN or the Internet. That is, the external interface 966 serves as a transmission unit in the imaging apparatus 960.

A recording medium to be mounted on the media drive 968 may be a readable/rewritable removable medium such as a magnetic disk, a magnetooptical disk, an optical disk, or a semiconductor memory. Also, a recording medium may be fixed to the media drive 968, to form a non-portable storage unit such as an internal hard disk drive or an SSD (Solid State Drive).

The control unit 970 includes a processor such as a CPU, and a memory such as a RAM or a ROM. The memory stores the program to be executed by the CPU, program data, and the like. The program stored in the memory is read by the CPU at the time of activation of the imaging apparatus 960, for example, and is then executed. By executing the program, the CPU controls operations of the imaging apparatus 960 in accordance with an operating signal input from the user interface 971, for example.

The user interface 971 is connected to the control unit 970. The user interface 971 includes buttons and switches for the user to operate the imaging apparatus 960, for example. The user interface 971 generates an operating signal by detecting an operation by the user via those components, and outputs the generated operating signal to the control unit 970.

In the imaging apparatus 960 having the above described structure, the image processing unit 964 has the functions of the image encoding device 100 (FIG. 1) and the functions of the image decoding device 200 (FIG. 11) according to the above described embodiments. Accordingly, for an image to be encoded and decoded in the imaging apparatus 960, the image processing unit 964 can transform the quantization parameter used in quantization into parameters, encode the parameters, correctly reconstruct the quantization parameter by decoding the parameters, and perform an inverse quantization process by using the quantization parameter. Thus, the imaging apparatus 960 can suppress the decrease in encoding efficiency caused by an increase in quantization accuracy.

It is of course possible to use an image encoding device and an image decoding device according to the present technique in any apparatuses and systems other than the above described apparatuses.

In the examples described in this specification, quantization parameters are transmitted from the encoding side to the decoding side. In transmitting a quantization matrix parameter, the quantization matrix parameter may not be multiplexed with an encoded bit stream, but may be transmitted or recorded as independent data associated with an encoded bit stream. Here, the term “associate” means to link an image (or part of an image, such as a slice or a block) included in a bit stream to the information corresponding to the image at the time of decoding. In other words, the information may be transmitted through a different transmission path from images (or bit streams). Also, the information may be recorded on a different recording medium (or a different recording area in the same recording medium) from images (or bit streams). Further, each piece of the information may be associated with frames, one frame, or part of a frame of images (or bit streams).

Although preferred embodiments of the present disclosure have been described above with reference to the accompanying drawings, the technical scope of the present disclosure is not limited to those examples. It is apparent that those who have ordinary skills in the art can make various changes or modifications within the scope of the technical spirit claimed herein, and it should be understood that those changes or modifications are within the technical scope of the present disclosure.

The present technique can also be in the following forms.

(1) An image processing device including:

a transform unit that transforms a quantization parameter used in quantization of image data into parameters; and

a transmission unit that transmits the parameters generated from the quantization parameter transformed by the transform unit.

(2) The image processing device of (1), wherein the transform unit transforms the quantization parameter into a first quantization parameter and a second quantization parameter.

(3) The image processing device of (2), wherein the transform unit sets the quotient obtained by dividing the quantization parameter by 2 as the first quantization parameter, and the remainder as the second quantization parameter.

(4) The image processing device of (3), wherein the transform unit realizes the division of the quantization parameter through a shift operation.

(5) The image processing device of any of (2) through (4), wherein the transform unit further calculates a difference first quantization parameter that is a difference value between the first quantization parameter of the current region being processed and a predicted first quantization parameter that is a predicted value of the first quantization parameter of the current region.

(6) The image processing device of (5), wherein the transform unit calculates the predicted first quantization parameter by using the first quantization parameter of an adjacent region of the current region.

(7) The image processing device of (6), wherein,

when the region adjacent to the left side of the current region is available, the transform unit sets the region adjacent to the left side of the current region as the adjacent region, and,

when the region adjacent to the left side of the current region is unavailable, the transform unit sets the region processed immediately before the current region as the adjacent region.

(8) The image processing device of any of (5) through (7), wherein the transmission unit encodes the difference first quantization parameter, and transmits the encoded difference first quantization parameter and the second quantization parameter.

(9) The image processing device of any of (1) through (8), further including

a quantization unit that quantizes the image data,

wherein the transform unit transforms the quantization parameter used in the quantization of the image data performed by the quantization unit, into parameters.

(10) The image processing device of any of (1) through (9), further including

an encoding unit that encodes the quantized image data,

wherein the transmission unit adds the parameters to encoded data of the image data generated by the encoding unit, and transmits the parameters added to the encoded data.

(11) An image processing method implemented in an image processing device,

the image processing method including:

transforming a quantization parameter used in quantization of image data into parameters, the transforming being performed by a transform unit; and

transmitting the parameters generated by transforming the quantization parameter, the transmitting being performed by a transmission unit.

(12) An image processing device including:

an acquisition unit that acquires parameters generated by transforming a quantization parameter used in quantization of image data; and

a reconstruction unit that reconstructs the quantization parameter by using the parameters acquired by the acquisition unit.

(13) The image processing device of (12), wherein

the acquisition unit acquires a difference first quantization parameter and a second quantization parameter, the difference first quantization parameter being a difference value between a first quantization parameter generated by transforming the quantization parameter of the current region being processed and a predicted first quantization parameter that is a predicted value of the first quantization parameter, the second quantization parameter being generated by transforming the quantization parameter of the current region, and

the reconstruction unit reconstructs the first quantization parameter of the current region by using the difference first quantization parameter of the current region acquired by the acquisition unit, and further reconstructs the quantization parameter of the current region by using the reconstructed first quantization parameter of the current region and the second quantization parameter of the current region.

(14) The image processing device of (13), wherein the reconstruction unit calculates the predicted first quantization parameter by using the first quantization parameter of an adjacent region of the current region, and reconstructs the first quantization parameter of the current region by adding the calculated predicted first quantization parameter to the difference first quantization parameter of the current region.

(15) The image processing device of (13) or (14), wherein the first quantization parameter is the quotient obtained by dividing the quantization parameter by 2, and the second quantization parameter is the remainder obtained by dividing the quantization parameter by 2.

(16) The image processing device of (15), wherein the reconstruction unit reconstructs the first quantization parameter of the current region by multiplying the first quantization parameter by 2 and adding the second quantization parameter.

(17) The image processing device of (16), wherein the reconstruction unit realizes the multiplication of the quantization parameter through a shift operation.

(18) The image processing device of any of (13) through (17), wherein the acquisition unit acquires the difference first quantization parameter by decoding the difference first quantization parameter encoded.

(19) The image processing device of any of (12) through (18), further including:

an inverse quantization unit that inversely quantizes the quantized image data by using the quantization parameter reconstructed by the reconstruction unit.

(20) An image processing method implemented in an image processing device,

the image processing method including:

acquiring parameters generated by transforming a quantization parameter used in quantization of image data, the acquiring being performed by an acquisition unit; and

reconstructing the quantization parameter by using the acquired parameters, the reconstructing being performed by a reconstruction unit.

### REFERENCE SIGNS LIST

100 Image encoding device
121 Quantization parameter encoding unit
151 Quantization parameter buffer
152 First quantization parameter calculation unit
153 Second quantization parameter calculation unit
154 First quantization parameter buffer
155 Predicted first quantization parameter calculation unit
156 Difference first quantization parameter calculation unit
200 Image decoding device
221 Quantization parameter decoding unit
251 Difference first quantization parameter buffer
252 Second quantization parameter buffer
253 First quantization parameter buffer
254 Predicted first quantization parameter calculation unit
255 First quantization parameter reconstruction unit
156 Quantization parameter reconstruction unit

1. An image processing device comprising:
a transform unit configured to transform a quantization parameter used in quantization of image data into a plurality of parameters; and
a transmission unit configured to transmit the parameters generated from the quantization parameter transformed by the transform unit.

2. The image processing device according to claim 1, wherein the transform unit transforms the quantization parameter into a first quantization parameter and a second quantization parameter.

3. The image processing device according to claim 2, wherein the transform unit sets a quotient obtained by dividing the quantization parameter by 2 as the first quantization parameter, and sets a remainder obtained by the division as the second quantization parameter.

4. The image processing device according to claim 3, wherein the transform unit realizes the division of the quantization parameter through a shift operation.

5. The image processing device according to claim 2, wherein the transform unit further calculates a difference first quantization parameter that is a difference value between the first quantization parameter of a current region being processed and a predicted first quantization parameter that is a predicted value of the first quantization parameter of the current region.

6. The image processing device according to claim 5, wherein the transform unit calculates the predicted first quantization parameter by using the first quantization parameter of an adjacent region of the current region.

7. The image processing device according to claim 6, wherein,
when a region adjacent to the left side of the current region is available, the transform unit sets the region adjacent to the left side of the current region as the adjacent region, and,
when the region adjacent to the left side of the current region is unavailable, the transform unit sets a region processed immediately before the current region as the adjacent region.

8. The image processing device according to claim 5, wherein the transmission unit encodes the difference first quantization parameter, and transmits the encoded difference first quantization parameter and the second quantization parameter.

9. The image processing device according to claim 1, further comprising
a quantization unit configured to quantize the image data,
wherein the transform unit transforms the quantization parameter used in the quantization of the image data performed by the quantization unit, into a plurality of parameters.

10. The image processing device according to claim 1, further comprising
an encoding unit configured to encode the quantized image data,
wherein the transmission unit adds the parameters to encoded data of the image data generated by the encoding unit, and transmits the parameters added to the encoded data.

11. An image processing method implemented in an image processing device,
the image processing method comprising:
transforming a quantization parameter used in quantization of image data into a plurality of parameters, the transforming being performed by a transform unit; and
transmitting the parameters generated by transforming the quantization parameter, the transmitting being performed by a transmission unit.

12. An image processing device comprising:
an acquisition unit configured to acquire a plurality of parameters generated by transforming a quantization parameter used in quantization of image data; and
a reconstruction unit configured to reconstruct the quantization parameter by using the parameters acquired by the acquisition unit.

13. The image processing device according to claim 12, wherein
the acquisition unit acquires a difference first quantization parameter and a second quantization parameter, the difference first quantization parameter being a difference value between a first quantization parameter generated by transforming the quantization parameter of a current region being processed and a predicted first quantization parameter that is a predicted value of the first quantization parameter, the second quantization parameter being generated by transforming the quantization parameter of the current region, and
the reconstruction unit reconstructs the first quantization parameter of the current region by using the difference first quantization parameter of the current region acquired by the acquisition unit, and further reconstructs the quantization parameter of the current region by using the reconstructed first quantization parameter of the current region and the second quantization parameter of the current region.

14. The image processing device according to claim 13, wherein the reconstruction unit calculates the predicted first quantization parameter by using the first quantization parameter of an adjacent region of the current region, and reconstructs the first quantization parameter of the current region by adding the calculated predicted first quantization parameter to the difference first quantization parameter of the current region.

15. The image processing device according to claim 13, wherein the first quantization parameter is a quotient obtained by dividing the quantization parameter by 2, and the second quantization parameter is a remainder obtained by dividing the quantization parameter by 2.

16. The image processing device according to claim 15, wherein the reconstruction unit reconstructs the first quantization parameter of the current region by multiplying the first quantization parameter by 2 and adding the second quantization parameter.

17. The image processing device according to claim 16, wherein the reconstruction unit realizes the multiplication of the quantization parameter through a shift operation.

18. The image processing device according to claim 13, wherein the acquisition unit acquires the difference first quantization parameter by decoding the difference first quantization parameter encoded.

19. The image processing device according to claim 12, further comprising:
an inverse quantization unit configured to inversely quantize the quantized image data by using the quantization parameter reconstructed by the reconstruction unit.

20. An image processing method implemented in an image processing device,
the image processing method comprising:
acquiring a plurality of parameters generated by transforming a quantization parameter used in quantization of image data, the acquiring being performed by an acquisition unit; and
reconstructing the quantization parameter by using the acquired parameters, the reconstructing being performed by a reconstruction unit.
